(19) United States
(12) Patent Application Publication
(10) Pub. No.: US 2022/0185625 A1
(43) Pub. Date: Jun. 16, 2022

(54) Camera-based sensing devices for performing offline machine learning inference and computer vision

(71) Applicant: Abacus Sensor, Inc., Chicago, IL (US)

(72) Inventor: Jordan Thomas One, Chicago, IL (US)

(73) Assignee: Abacus Sensor, Inc., Chicago, IL (US)

(21) Appl. No.: 17/551,177

(22) Filed: Dec. 14, 2021

Related U.S. Application Data
(60) Provisional application No. 63/125,975, filed on Dec. 15, 2020.

(51) Int. Cl. B66B 5/00; B66B 1/34; B66B 1/28; G06V 20/52; G06V 10/82; G06V 10/44; G06V 10/26

(52) U.S. Cl. CPC B66B 5/0012; B66B 1/3461; B66B 1/28; G06F 17/15; G06V 10/82; G06V 10/454; G06V 10/26; G06V 20/53

(57) ABSTRACT

A sensor module includes at least a camera module and one or more machine learning (ML) inference application-specific integrated circuits (ASICs), which are configured to detect the presence of people in an elevator. The sensor module includes at least one processor, which executes instructions that enable the sensor module to detect, count, and anonymously track one or more persons in an elevator. The sensor module may also sensors, such as an accelerometer and an altimeter, which are used to estimate the kinematic state of the elevator. The camera, ML ASIC(s), sensors, and embedded application enable the sensor device to anonymously monitor the movement of people through a building via the elevator. The ML ASIC(s) allow the sensor module to count occupants in the elevator in near-real time, enabling the sensor to transmit signals for controlling aspects of the elevator system.

### CROSS-REFERENCE TO RELATED APPLICATION

The present application claims priority to, and the benefit of, U.S. Provisional Patent Application No. 63/125,975 filed on Dec. 15, 2020, the contents of which are incorporated herein by reference.

### FIELD OF THE DISCLOSURE

The present disclosure relates generally to camera-based sensors and edge devices for performing machine learning inference and computer vision tasks. More particularly, embodiments of the present disclosure relate to performing object detection, object tracking, image segmentation, and other computer vision tasks to detect one or more objects within the field-of-view (FOV) of one or more cameras, and to output one or more signals in response to control one or more aspects of an elevator.

### BACKGROUND OF RELATED ART

Traditionally, sensor devices made for elevators detect the movement or presence of persons and/or objects. For example, an infrared detector may detect the motion, presence, or proximity of a person or object positioned in the doorway connecting a floor of a building to an elevator cab and responsively prevent the elevator door from closing, and/or cause the elevator door to re-open if it is partially closed. Such traditional proximity and motion sensors lack the capability of determining the type of object that is present within the sensor's FOV—rather, the particular operation(s) carried out upon a detection event are the same, whether the object is a person, a jacket, a backpack, or any object. In the context of a sensor for preventing closure of elevator doors, the inability to discern which object is present in the doorway may not be particularly relevant, as there is a general desire to prevent any object (animate or inanimate) from getting stuck by the elevator door.

Another category of sensor devices for elevators are used to determine the total amount of weight within the elevator cab (commonly referred to as “load weighing” sensors). The particular manner in which a load weighing sensor is implemented may vary among different types of elevators (e.g., different load weighing sensors for rope-suspended elevators, hydraulic elevators, etc.). Load weighing sensors often operate by detecting the total amount of weight in the elevator cab, and output one or more signals indicative of the detected weight. If the total weight in the cab exceeds a threshold (e.g., the maximum weight capacity for a given elevator), a control system for the elevator may responsively take one or more actions—the most common of which is referred to as “hall call bypass” (also referred to herein simply as “bypass”). In operation, when the total weight exceeds a threshold maximum, the elevator cab will skip or bypass floors that it might otherwise stop at to pick up additional passengers (e.g., floors at which passengers have pressed the hall call button to summon the elevator). As a result, a fully loaded elevator (by total weight) may effectively take an express trip to the nearest destination (e.g., the closest floor for which the button was pressed inside of the elevator, the ground floor of the building, etc.). However, load weighing sensors lack the ability to discern any more information about the particular contents within an elevator cab. Thus, an elevator cab could be loaded with a few heavy set persons, many lightweight persons, or a stack of iron ingots—and all may appear to be the same from the perspective of the load weighing sensor, which simply determines the total weight within the elevator cab.

In the modern era, there exists growing demand for improving the hygiene, safety, efficiency, and overall function of elevator systems. For example, significant worldwide public health events have spurred a strong desire to limit the number of persons within the elevator cab at a time. However, none of the existing sensor systems are able to accurately determine such information, such that the myriad edge cases would not be accounted for (e.g., due in part to the fact that people come in all shapes and sizes). In addition, a multitude of safety systems have arisen that attempt to limit the specific persons who are permitted to access an elevator system, such as gates and card readers, which require input of some credential and may serve to limit the floor choices of an individual based on those credentials. However, these security systems lack the ability to, for example, detect whether a particular individual is actually the person related to the credentials, or whether that person is carrying a weapon or some other item on them. Furthermore, elevator systems equipped with typical sensor devices may not be able to accurately assess the efficiency of elevator dispatching (particularly in the context of balancing elevator loading for dispatch purposes), such that a given control scheme may lead to unnecessarily long travel times resulting in excess energy consumption.

Accordingly, an object of the present disclosure is to provide a sensor device that is capable of improving the hygiene, safety, efficiency, and overall function of elevator systems, in a manner that surpasses the functionality of existing sensor systems.

In addition, with the advent of the “Internet of Things” (IoT), there exists a growing demand for “smart” devices that collect information and improve the performance or operation of a particular system over time. For example, some “smart” thermostats may not only detect the temperature and other environmental conditions over time, but may also record user inputs (e.g., setting a desired temperature) over time to learn that user's patterns, and to trigger the operation of a home's or building's HVAC system in a manner that balances energy efficiency and comfort. In the context of elevator systems, there exists an ongoing desire to improve the elevator's performance (e.g., average time to pick up passengers, average trip time per passenger, etc.), and to improve the elevator's efficiency (e.g., average energy consumption over time as it relates to the overall distance that the elevator travels, pre-positioning of elevator cabs at various floors to reduce the average distance travelled by the elevators over time, etc.).

Accordingly, an object of the present disclosure involves providing a sensor device that is capable of sensing and gathering information, which may at least in part provide the basis for optimizing elevator performance and efficiency. Note that, as described herein, the term “optimizing” generally refers to improving the performance or efficiency of an operation, function, feature, system, or some combination thereof, regardless of whether the end result of said optimization is the theoretical optimum performance of that operation, function, feature, system, or some combination thereof.

### SUMMARY

As described above, there exists an increasing desire for “smart” sensors to improve the hygiene, safety, efficiency, and performance of elevator systems. Embodiments of the present disclosure address the shortcomings of prior sensor systems by providing a camera-based edge device capable of performing machine learning (ML) inference on-device, without leveraging any networked or cloud-based processing power to carry out the ML inference tasks. In particular, embodiments of the present disclosure utilize computer vision (CV) and object detection methods—such as convolutional neural networks (CNNs) and/or other deep learning networks—for detecting objects (e.g., persons, objects on those persons, etc.) within the interior of the elevator cab. Traditionally, and continuing into the present day, the performance of these ML tasks has required significant computing power, and therefore involved either a powerful workstation with a high-performance graphics processing unit (GPU), or a cloud-based solution with a cluster of central processing unit (CPU) and/or GPU cores.

However, both workstation- and cloud-based solutions are incompatible with elevator systems for a number of significant reasons. Workstation-based solutions are typically large in size and product significant amounts of heat, and therefore would be difficult to integrate within the small space of an elevator cab without creating a custom computer layout or otherwise taking up a non-trivial amount of space within the elevator cab.

Perhaps more significantly, cloud-based solutions are largely incompatible with elevator systems because most elevator cabs lack a stable, high-speed Internet connection that is needed to perform cloud-based ML inference (e.g., by streaming video data over a wide area network such as the Internet). Nearly all elevator cabs are constructed from metal enclosures which act as Faraday cages, and are situated within fortified, thick-walled elevator shafts. As a result, most wireless signals—particularly, high-frequency signals capable of supporting high-speed data transmissions—are significantly dampened to the point of being inoperable or only periodically operable. Moreover, to provide high-speed data connections in the form of an Ethernet connection (e.g., Cat5, Cath, etc.) to an elevator cab, an Ethernet cable would have to extend along the electrical wiring harness that is suspended beneath the elevator (referred to herein as the “traveling cable”). However, most existing laws and regulations pertaining to elevator systems prohibit the use of Ethernet cables in traveling cables. As a result, ML-based CV solutions that require continuous, fast Internet connectivity to operate are simply inoperable within the elevator cab. Thus, despite the many advances in ML and CV in recent years, and the various existing general (e.g., non-elevator related) solutions that implement state-of-the-art ML and CV on their platforms, none of these solutions are suitable for use in an elevator cab.

Given these clear constraints and limitations, embodiments of the present disclosure include camera-equipped edge devices that include one or more application-specific integrated circuits (ASICs) that implement a configurable hardware-based neural network designed to minimize memory access operations and perform common ML computing operations (e.g., kernel convolutions, other matrix multiplication, apply activation functions such as the sigmoid activation function, etc.), which has been referred to as a tensor processing unit (“TPU”) or a neural processing unit (“NPU”). The performance of ML inference that might have otherwise been performed by a series of CPU and/or GPU operations is instead performed by the TPU, increasing the performance of ML inference by at least an order of magnitude while significantly reducing CPU load and overall power consumption. Some modern TPU chips have been constructed to fit within sub-centimeter packages, and are capable of performing trillions of operations per second (TOPS).

Embodiments of the present disclosure involve providing a hardware architecture that leverages the TPU for performing complex CV and ML tasks entirely “offline”—that is, without offloading ML tasks to a separate networked computing device and/or cloud server. Specifically, various embodiments of the present disclosure involve training task-specific models or neural networks to detect particular objects with a high degree of accuracy given the environmental constraints (e.g., various elevator interiors) and distortion resulting from wide-angle camera lenses. The particular training techniques and context-specific considerations are described in greater detail below.

The hardware architecture of the devices according to the present disclosure may comprise one or more cameras which, either alone or in combination, provide a field-of-view (FOV) of the devices. Elevator cabs are typically small in size, with persons potentially standing at each corner of the elevator. As a result, in order to provide a FOV that is able to see persons positioned throughout the elevator, a wall-mounted or ceiling-mounted camera module may include at least one imager with a wide-angle lens (e.g., horizontally, 160° to 205°, preferably 175° to 190°; vertically, 70° to 180°, preferably 90° to 130°). In some embodiments, two or more imagers each having comparably narrower FOVs may be combined to form a single camera module, with each of their FOVs stitched together (in software and/or in hardware) to form a panoramic or effectively wide-angle view with less distortion.

The hardware architecture of the devices according to the present disclosure may comprise one or more displays, which may depict graphics, alphanumeric characters, animations, and/or some combination thereof to display information related to the status of the device, perform diagnostics, provide branding and other notices, and/or to otherwise communicate with the passengers of the elevator. In some embodiments, the device may perform object detection to determine the number of persons present within the FOV of the camera module, and the display may be used to convey this number through some combination of graphics and/or alphanumeric characters to the passengers in the elevator cab. In addition, the display may display graphics and/or alphanumeric characters if the elevator cab exceeds a maximum occupancy threshold, to indicate to the passengers that the elevator cab capacity has been exceeded and possibly encourage one or more passengers to exit the elevator cab. Furthermore, the display may display information related to the operation of the elevator, such as an indication that the elevator has engaged a bypass or “express” mode once the capacity of the elevator has been reached. Other display elements beyond those explicitly stated herein may also be used, all of which are encompassed within the scope of the present disclosure.

In addition, the hardware architecture of the devices according to the present disclosure may comprise one or more speakers, which may provide auditory feedback, messages, chimes, and/or other sounds related to the operation of the devices. For example, the speakers may be used to generate sounds that convey some aspect of the device's detection or operation (e.g., sounds related to the counting of individuals, a sound when capacity is met, a sound or message when elevator cab exceeds capacity, etc.). In some cases, the speakers may be used to produce audible counterparts to visual graphics, for the purposes of increasing the accessibility of the device for vision-impaired persons. The speakers may further be used to convey information about the status of the device, as an alternative means of determining device status if the display malfunctions. Other speaker uses are also possible as it relates to a given device's operation, and are encompassed within the scope of the present disclosure, even if not explicitly contemplated.

Further, the hardware architecture of the devices according to the present disclosure may comprise one or more accelerometers, gyroscopes, inertial measurement units (IMUs), and/or any other sensing device for determining the orientation, position, velocity, and/or acceleration of the device. For example, accelerometers within the device may be used to detect acceleration of the elevator cab, from which velocity and/or position information may be derived. As a specific example, a device according to the present disclosure may record the number of persons in the elevator, along with the direction in which those persons are traveling (e.g., up or down)—with the direction of travel being derived from accelerometer data. As a result, the passenger capacity data may include additional context, which may be processed to determine various metrics or performance indicators (e.g., the average inbound trip duration as compared to average outbound trip duration, busy times of day for inbound traffic as compared to outbound traffic, average trip distance as derived from the twice-integrated acceleration data over a period of time during which persons are detected in an elevator cab, etc.). As will be appreciated by a person of skill in the art, it may be difficult to determine the direction of elevator travel by observing only image and/or video data; thus, an accelerometer or the like may serve to provide additional context about object detections and/or other sensor data gathered during operation.

In some embodiments, a barometric pressure sensor or altimeter may be used instead of, or in addition to, an accelerometer for determining an elevators position, velocity, and/or acceleration. The barometric pressure sensor may be used to determine the current barometric pressure of the sensor module, which may be translated into the sensor module's relative and/or absolute altitude above sea level. In some implementations, the sensor module may obtain information from a weather service or other application programming interface (API) to determine the barometric pressure at sea level, and then formulaically determine the altitude (e.g., meters above sea level) of the sensor module at a given point in time. Alternatively, the barometric pressure sensor may include a built-in co-processor or integrated circuit that calculates the altitude of the sensor module, and outputs digital information indicative of that altitude to the sensor module's main processor. Regardless of the particular implementation, the sensor module may include a barometric pressure sensor, which may be polled periodically to determine the elevator's position (e.g., height above sea level, height relative to the ground floor, etc.), velocity (e.g., a change in the elevator's position across two or more pressure measurements), and/or acceleration. Where a particular building's floor heights are known, the sensor module (or other processing device) may convert the altitude data into floor data, such that the floor at which an elevator is positioned at a given time may be determined automatically.

The foregoing summary is illustrative only and is not intended to be in any way limiting. In addition to the illustrative aspects, embodiments, and features described above, further aspects embodiments, and features will become apparent by reference to the figures and the following detailed description and the accompanying drawings.

### BRIEF DESCRIPTION OF THE DRAWINGS

FIG. 1 is an exploded perspective view of an example sensor module, according to an example embodiment of the present disclosure.

FIG. 2 is a conceptual diagram illustrating an example system architecture, according to an example embodiment of the present disclosure.

FIG. 3 is a wiring diagram illustrating an example system layout for the sensor module, elevator, and machine room, according to an example embodiment of the present disclosure.

FIGS. 4A-4C illustrate example elevator loading scenarios, according to various embodiments of the present disclosure.

FIGS. 5A-5K illustrate example scenarios and example techniques that pertain to each respective scenario, according to various embodiments of the present disclosure.

FIG. 6 is a flowchart of an example method performed by the example sensor module, according to an example embodiment of the present disclosure.

FIG. 7 is a flowchart of an example method performed by the example sensor module, according to an example embodiment of the present disclosure.

FIG. 8 is a flowchart of an example method performed by the example sensor module, according to an example embodiment of the present disclosure.

FIG. 9 is a flowchart of an example method performed by the example sensor module, according to an example embodiment of the present disclosure.

FIG. 10 is an example management user interface for managing a plurality of elevators, according to an example embodiment of the present disclosure.

FIG. 11 is an example state machine for determining the kinematic state of an elevator, according to an example embodiment of the present disclosure.

FIG. 12 is an example timing diagram of an example concurrent pipeline optimization, according to an example embodiment of the present disclosure.

### DETAILED DESCRIPTION

The following description of example methods and apparatus is not intended to limit the scope of the description to the precise form or forms detailed herein. Instead the following description is intended to be illustrative so that others may follow its teachings.

As described above, a device (also referred to herein as a “sensor module”) may include a variety of transducers, imagers, and/or other sensors that collect information about the elevator and/or the contents within the elevator. The sensor module may include a camera module formed from an image sensor, a lens mount, and one or more lenses which captures image and/or video data of a particular FOV and outputs information indicative of that image and/or video data to one or more processors for analysis. The captured images and/or video data may be provided to a machine learning inference hardware accelerator, such as a graphics processing unit (GPU), a neural processing unit (NPU), a tensor processing unit (TPU), and/or another

In addition, the sensor module may include one or more of an accelerometer, a gyroscope, a magnetometer, an inertial measurement unit (IMU), a barometric pressure sensor, an altimeter, and/or a passive infrared (PIR) sensor, among other possible sensors, which may provide additional context about the elevator, the elevator's operation, and/or other context. For example, one or more sensor(s) may be used to estimate the device's position, velocity, acceleration, and/or orientation. In some cases, the sensor(s) may detect particular events, such as acceleration events that indicate when an elevator transitions from a parked state to a moving state, and vice versa. In some embodiments, the outputs from two or more sensors may be “fused” or combined to determine the state of the device and/or the state of the elevator. For example, accelerometer data may be combined with barometric pressure data to estimate the elevator's velocity in a way that is more accurate and/or less noisy than might otherwise be estimated using only the accelerometer or barometric pressure sensor. Combining sensor outputs in this manner may be referred to herein as “sensor fusion.”

The device may include one or more processors, memory, and data storage (e.g., hard disk drive, solid state disk, flash storage such as embedded multimedia cards (eMMCs), etc.) storing program files, configuration files, scripts, and/or other instructions for executing one or more programs, applications, services, daemons, and/or other processes. For example, the data storage device may store instructions thereon that execute a series of operations and/or sub-routines that are collectively referred to herein as the “event loop.” An event loop may include steps for capturing sensor and/or image data, processing that sensor and/or image data to determine the state of the device, the elevator, and information about objects present within the elevator, and one or more actions performed responsive to the detected state of the device, the elevator, and/or the objects present within the elevator. For example, an event loop according to the present disclosure may involve capturing image data of a scene (e.g., the interior of an elevator cabin), performing object detection inference using a deep neural network (DNN) to determine the locations (e.g., bounding boxes) of persons within the image, if any, and outputting one or more control signals to the elevator, elevator controller, and/or elevator dispatcher to influence the operation of the elevator. As a specific example, the event loop may involve counting the number of persons present in the frame, determining whether that number meets or exceeds a threshold number, and outputting a programmable logic controller (PLC) signal (e.g., a voltage between 0 and 24 volts) to initiate a hall call bypass mode for the elevator (e.g., utilizing the load weigh bypass line for the elevator). A variety of potential operations are described herein, any combination of which may form an “event loop” for a particular implementation.

In some embodiments, the event loop may also involve storing and/or transmitting data about the state of the device, the state of the elevator, and/or the objects present within the elevator. For a given event loop, information about the device's location (e.g., which floor the elevator is on), the device's motion (e.g., whether the elevator is moving or stationary, and/or the elevator's velocity, acceleration, jerk, etc.), the number of persons present in the elevator, how long each of the persons have been present within the FOV of the camera, and/or other details. In some cases, the device may implement a finite state machine (FSM) in which the elevator's particular state (e.g., parked, stopped, moving upward, moving downward, accelerating, decelerating, loading passengers, unloading passengers, etc.) is tracked by monitoring for transition conditions from sensor inputs, machine learning inferences, and/or information derived therefrom. As described in more detail herein, the device may use the state of the device to determine whether or not to perform an operation. For instance, if the device detects that the elevator is moving and recently signaled to activate a hall call bypass feature in the elevator controller, the device may continue to enable hall call bypass, even if the number of detected persons changes while in motion (e.g., false negatives or due to errors with the model). In other words, the device may use context in order to increase robustness to potential errors or inaccuracies of a machine learning model.

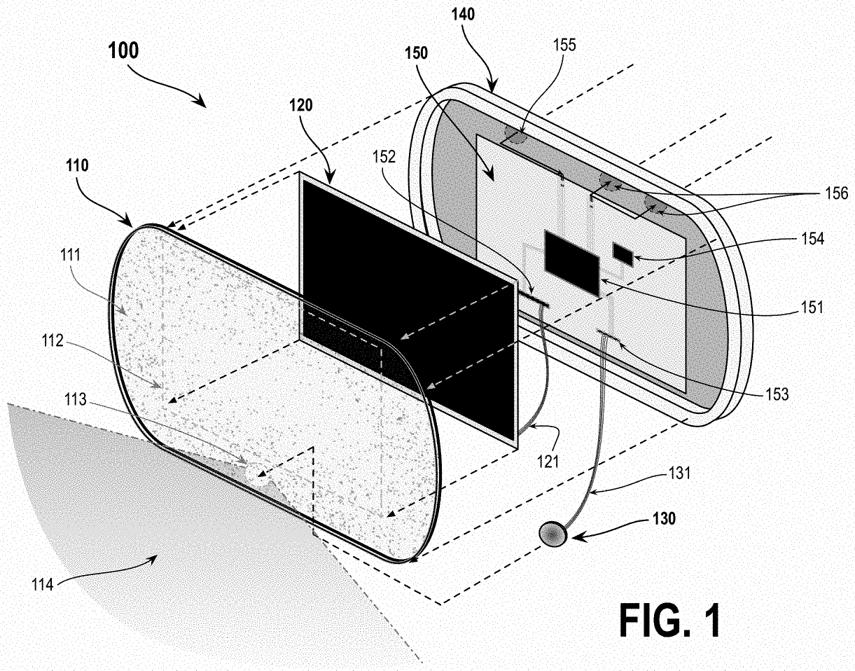

Referring now to FIG. 1, an example sensor module 100 includes a front panel 110, a display module 120, a camera module 130, a housing 140, and a baseboard 150. The front panel 110 may be constructed from a transparent or translucent material 111, such as polycarbonate, acrylic, glass, or another suitable material. A display region 112 may be specified in alignment with the display module 120, and a camera region 113 may likewise be specified in alignment with the camera module 130. The areas outside of the display region 112 and the camera region 113 may, in some implementations, be coated with an opaque material that prevents the transmission of light and obscures the interior of the device from being visible externally when the device is assembled.

The display module 120 may be any suitable display technology, such as liquid crystal display (LCD) technology, organic light emitting diode (OLED) technology, or the like. The display module 120 may include thereon (or otherwise be electrically coupled thereto) a driver circuit to provide power to the display, and to control the pixels of the display. The display module 120 may be communicatively coupled to the baseboard 150 via a cable 121, such as a High-Definition Multimedia Display (HDMI) cable, a Mobile Industry Processor Interface (MIPI) Display Serial Interface (DSI) ribbon cable, or any other suitable cable to match the interface between the display module 120 and the connector 152 of the baseboard 150.

The camera module 130 may include one or more of an image sensor, a lens assembly, an image signal processor, and/or hardware for mounting the camera module 130 in a desired orientation within the sensor module 100. The camera module 130 may include a wide angle lens or a fisheye lens (or some combination of lens elements) that enables the camera module 130 to have a desired field of view (FOV) 114. Although the FOV 114 may vary among different implementations, the horizontal FOV and vertical FOV may be such that FOV 114 covers the whole interior of an elevator. As a specific non-limiting example, the FOV 114 may include a horizontal FOV of at least 170 degrees, and a vertical FOV of at least 90 degrees in order to cover a person standing almost immediately below and to the left or right of a sensor module 100 mounted on an elevators front transom panel above the elevator doors at an approximately 7 foot height. It will be understood that the specific FOV, mounting position, and/or requirements may vary in different applications, particularly for elevators of non-standard sizes or configurations. The camera module 130 may be communicatively coupled to the baseboard 150 via a cable 131, such as a Universal Serial Bus (USB) cable, a Mobile Industry Processor Interface (MIPI) Camera Serial Interface (CSI) ribbon cable, or any other suitable cable to match the interface between the camera module 130 and the connector 153 of the baseboard 150.

The baseboard 150 may include some combination of processor(s), memory, data storage elements, power management circuitry, sensor(s), and/or other elements typically found in circuit boards such as electrostatic discharge protection components, voltage regulation components, and the like. The baseboard 150 may include a processing device 151, which may include one or more processors, memory, and data storage. In some implementations, the processing device 151 may be a system-on-a-chip (SoC), encompassing various components to form a computing device on a chip. In other implementations, the processing device 151 may be a system-on-a-module (SoM), which includes a SoC and other integrated circuit(s) such as a GPU, a video processing unit (VPU), an image signal processor (ISP), a cryptography chip, integrated circuits for interfacing with external devices, and/or other integrated circuits. Regardless of the particular implementation, the processing device 151 may include a combination of elements that collectively form a computing device.

The baseboard 150 also includes a tensor processing unit (TPU) 154. The TPU 154 may be an application-specific integrated circuit (ASIC) for performing hardware-accelerated machine learning inference. The TPU 154 may be in communication with the processing device 151 via USB, serial bus, SATA, PCI, or another suitable communication bus. The TPU 154 may include thereon a combination of tensor units and an onboard memory configured such that the TPU 154 can be programmed to implement a pre-trained neural network, such as a convolutional neural network. Once the TPU 154 has been initialized with a particular network architecture and set of weights, the TPU 154 may receive input data (e.g., pixel data from an image or video frame), process that input data by propagating that input data through the neural network, and output the results of that input data (e.g., confidence interval(s) associated with one or more classes of objects, bounding box coordinates, etc.).

The baseboard 150 may also include some combination of input wires 155 and output wires 155. The input and output wires 155, 156 may include power lines and/or data lines in order to supply power to the sensor module 100, communicate with a gateway, and/or to control various elements of the elevator. For example, the output wires 156 may include a relay-connected wire for activating a hall call bypass feature. The input wires 155 may carry either AC power, or DC power, depending on the particular implementation. The input and output wires 155, 156 may further include one or more serial communication wires for communicating with a device gateway over a serial connection, such as an RS-232, RS-422, RS-485, CAN bus, or other suitable serial communication physical standard.

The baseboard 150 may also include other elements in addition to those that are shown in FIG. 1. For example, the baseboard 150 may include thereon sensors to aid the sensor module 100 in determining the state of the device. As a particular example, the baseboard 150 may include a barometric pressure sensor for estimating the altitude of the device. As another example, the baseboard 150 may include an accelerometer or inertial measurement unit (IMU) for estimating the acceleration and/or orientation of the device. Other sensors are also possible.

Further, it will be appreciated that a particular baseboard 150 may include fewer or more elements than those explicitly described herein. Accordingly, the present disclosure is not limited to the configurations explicitly shown or described in the present application.

In addition, the display 120 may be omitted in some applications. For instance, the sensor module 100 may be housed within an enclosure and mounted to the top of an elevator car (referred to herein as the “car top”). In this example implementation, the camera module 130 may be connected to the sensor module 100 via a cable (e.g., a USB cable or another cable that supplies a data connection and/or power to the camera module 130), with the camera module 130 being mounted on the interior of the elevator cab. It will be appreciated that the use of a display to interact with passengers in an elevator is an optional aspect of the present disclosure, and that other forms of the sensor module 100 are also contemplated herein.

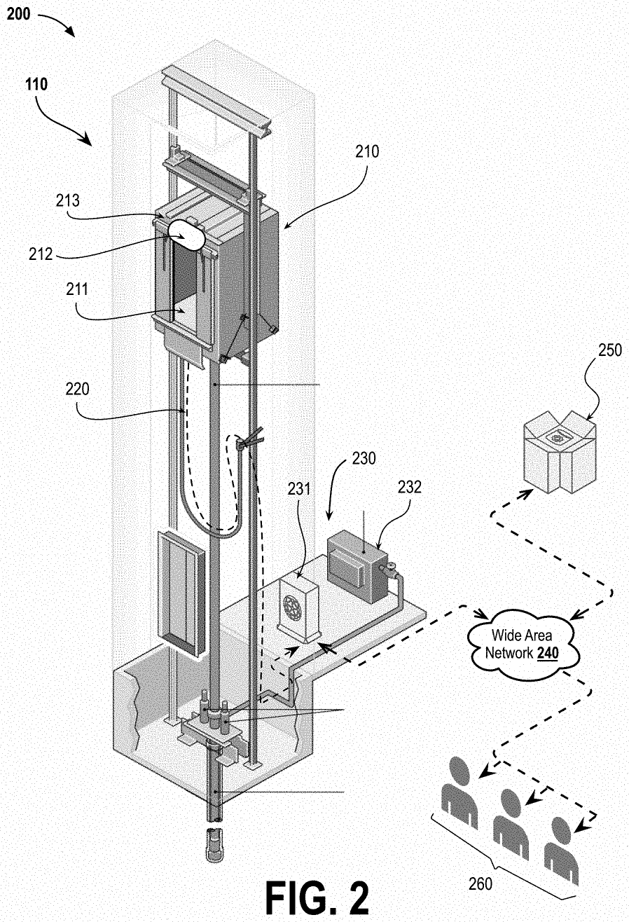

FIG. 2 depicts a conceptual diagram of an example system architecture 200, according to an example embodiment of the present disclosure. The system 200 includes an elevator 210, a traveling cable 220, a machine room 230, a wide area network 240, a backend server 250, and users 260. The elevator 210 may be installed within and travel through a hoistway in a building. The traveling cable 220 may be a bundle of wires or cables that are physically and electrically coupled to the elevator 210 and extend along the hoistway to the machine room 230. The machine room 230 may include hardware and/or electronics to drive the elevator, such as the motor 232 and the elevator controller.

The interior 211 of the elevator 210 may include a front transom panel 213 that extends horizontally above the elevator doors. In various elevators, the front transom panel 213 may be a sheet of metal or other material that extends between the elevator doorway and the ceiling of the elevator's interior. In this example, a sensor module 212 may be surface mounted or panel mounted to the front transom panel 213 and facing the interior 211 of the elevator 210. The sensor module 212 includes data lines that are communicatively coupled to one or more wires in the traveling cable 220. The particular communication protocol used may depend on the length of the traveling cable 220. For example, for high rise buildings with traveling cables that exceed 100 feet in length, one or more shielded twisted pairs in the traveling cable may carry RS-485 or CAN bus messages from the sensor module 212 to the gateway 231, such that the serial communication protocol is operational across the long-distance wires.

The gateway 231 may be a computing device that is adapted to send messages to and receive messages from the sensor module 212 over one or more communication protocols, and direct those messages to the backend server 250 over the wide area network 240. In some examples, the gateway 231 may route TCP/IP packets from the sensor module 212 to the backend server 250, effectively enabling the sensor module 212 to be Internet-connected via the IP stack. In other examples, the gateway 231 may receive packets from the sensor module 212, convert the data into TCP/IP packets, and convey those packets to the backend server 250 via the wide area network 240. Conversely, the gateway 231 may receive messages, instructions, commands, and/or data from the backend server 250 and redirect those messages, instructions, commands, and/or data to the sensor module 212 (e.g., to enable over-the-air (OTA) updates, to tunnel into the sensor module 212 remotely, to enable or disable features of the sensor module 212, etc.). Regardless of the particular implementation, the gateway 231 may provide a communication bridge between the sensor module 212 and a network (e.g., a local area network, a wide area network, the Internet, etc.) to enable the sensor module 212 to be managed remotely.

The wide area network 240 may be any network that connects various local area networks (LANs), such as the Internet.

The backend server 250 may include a combination of hardware and/or software for remotely managing the sensor module 212. The backend server 250 may store logs and/or data captured by the sensor module 212, store software updates for the sensor module 212, and provide a virtual machine for tunneling into the sensor module 212 (e.g., over secure shell (SSH)), among other functions.

In some embodiments, the backend server 250 may provide a front end interface, such as a web application, that is accessible to users 260 (e.g., building operators, property managers, portfolio managers, consultants, etc.). The users 260 may access such a web application to view the status of the sensor module 212 (or other sensor modules in their building or portfolio), to control various aspects of the sensor module 212 (e.g., update settings, change thresholds, enable or disable features, etc.), and/or to view the data collected by the sensor module 212 over a period of time and/or insights derived therefrom.

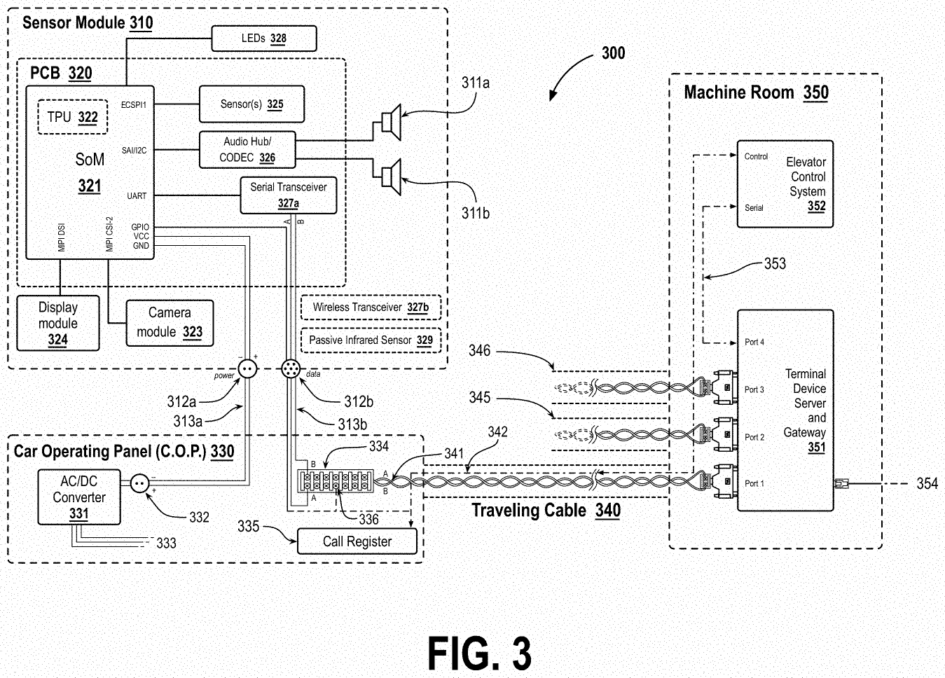

FIG. 3 is a wiring diagram 300 illustrating an example system layout for a sensor module 310, an elevator car operating panel (COP) 330, and a machine room 350, according to an example embodiment of the present disclosure. The sensor module 310 includes power wires 313a and data wires 313b which extend into the elevator COP 330. As described herein, the “COP” generally refers to the space behind the button panel in an elevator that typically includes screw terminals, electronic equipment, and power outlets. Further, as described herein, the term “data wires” may refer to any wire, cable, or line that carries a signal of information or control (e.g., serial data signals, high/low voltage to control an external device, open/closed dry contact relay output to control an external device, a 4-20 mA programmable logic controller (PLC) signal, and/or other forms of information or control).

The elevator COP 330 provides DC power to the sensor module 310 by converting AC input power 333 with an AC/DC converter 331, the output of which may be connected to the power wires 313a via a connector 332. The data wires 313b may include, in some embodiments, one or more wires that electrically couple with corresponding one or more wires in the traveling cable 340. In various embodiments, the data wires 313b may additionally or alternatively include one or more wires that couple with a bypass activation terminal 336, which is used to control whether or not a hall call bypass or load weigh bypass feature of the elevator controller is activated. The traveling cable 340 provides power and communication between the elevator COP 330 and the machine room 350. As a specific example, a half-duplex RS-485 connection comprising AB lines may extend from the sensor module 310, through a connector 312b, along data wires 313b and into a terminal 334, which in turn is coupled to a twisted pair of wires 341, 342 that extend along the traveling cable 340. These half-duplex RS-485 wires 341, 342 in the traveling cable 340 may couple to a connector (e.g., a DB9 connector) which is plugged into a terminal device server and gateway 351 in the machine room 350. The terminal device server and gateway 351 may also be communicatively coupled to the building's local area network (and/or to the Internet) via Ethernet cable 354. In this manner, data and commands may be transmitted to and from the sensor module 310 along the communication path described above and shown in FIG. 3.

Although not explicitly shown, other networking arrangements may also be used. For example, the sensor module 310 may transmit data wirelessly via Wi-Fi, Bluetooth, Zigbee, LoRaWAN, and/or other wireless networking protocols instead of sending data over a wired connection through the traveling cable 340. For instance, a hospital building may include strong, continuous Wi-Fi throughout the building—including the elevators—to provide constant networking to medical devices as patients are moved through the building. For such a building, Wi-Fi-based networking may be possible and/or desirable over a wired serial data connection. However, due to the electromagnetic isolation experienced by elevators due to thick elevator shafts and the substantial diminution of electromagnetic waves due to the Faraday cage effect of the metal elevator cabin, wired data connections or reliable long-distance wireless communications may be preferred over higher speed but shorter distance methods. Further, although a half-duplex RS-485 arrangement is shown in FIG. 3, other arrangements may be used instead, such as 1-wire serial communication, RS-232, full duplex RS-485, CAN bus, and/or other wired serial communication techniques.

In some cases, a building may include a bank of elevators which use one or two machine rooms to house the motor and elevator controller. In these instances, the terminal device server and gateway 351 may receive data connections from multiple sensor modules in different elevators via their respective traveling cables 345, 346. The terminal device server and gateway 351 may, in some implementations, permit for local communication to other sensor modules for more advanced control, and/or to provide a more comprehensive understanding of how people move through a building.

In some embodiments, information output by the sensor module 310 may be directly or indirectly provided as an input to an elevator control system 352. The elevator control system 352 may be an electromechanical or electronic device that automatically controls the elevator by causing the elevator to respond to hall calls to pick up waiting passengers. In more modern systems, the elevator control system 352 may include a microcontroller or microprocessor that implements a program or algorithm to control multiple elevators, which are referred to as “call allocation systems,” “destination dispatch,” and other names by various elevator manufacturers. Regardless of the particular elevator control system 352, one or more outputs (e.g., a low/high voltage output, an open/closed contact output, a PLC signal, CAN bus data wires, etc.) of the sensor module 310 may be fed into the elevator control system 352 to provide information thereto to inform and enhance its dispatching capabilities. For example, the elevator control system 352 may receive data indicative of the number of persons in an elevator, determine that the elevator has reached a maximum occupancy threshold, and subsequently cause that elevator to skip hall calls until at least one of the passengers exits the elevator. As another example, the elevator control system 352 may receive data indicative of the number of persons in an elevator from multiple elevators, and dispatch the elevator with the lowest occupancy to pick up a waiting passenger that has called the elevator. For more advanced elevator dispatching algorithms (e.g., estimated time to destination systems, proprietary destination dispatch systems, etc.), the number of persons in the car may be used as one of multiple inputs that are processed to determine the optimal allocation of elevator cars to achieve one or more goals (e.g., maximize handling capacity, prevent elevator overcrowding, minimize wait times, etc.). This information may, in some arrangements, be provided directly to an elevator controller (e.g., a PLC input line), or indirectly (e.g., via a serial data forwarded through the terminal device server and gateway 351).

In some cases, an elevator may include a call register 335 that stores thereon registered hall calls from various floors in the building. For example, a hall call button on a floor may be depressed by a waiting passenger, which latches or is otherwise registered to the call register 335 associated with an elevator. The elevator controller may direct the elevator to respond to hall calls registered in the call register 335 to, in turn, pick up those waiting one or more passengers. In some systems, activating hall call bypass may involve preventing the call register 335 from latching or otherwise registering hall calls when hall call bypass is enabled or in an active state. In other systems, activating hall call bypass may involving cancelling one or more of the hall calls registered in the call register 335 (e.g., elevator car call cancellation). Other methods of bypassing floors may also be possible. It will be appreciate by those of skill in the art that the terms “hall call bypass,” “load weigh bypass,” and the like may generally refer to a technique for cancelling, avoiding, skipping, or otherwise not responding to one or more call calls.

In some implementations, the sensor module 310 may be electrically coupled with one or more features of the elevator other than the hall call bypass or load weigh bypass system. For example, the sensor module 310 may be wired into a feature commonly referred to as “attendant service” (AS) or “manual operation” which, upon activation, causes some or all of the elevator's automatic functionality to be disabled. In many systems, AS mode may prevent the elevator from automatically responding to hall calls, and/or from automatically opening and closing the elevator doors, among other changes in functionality. As described herein, “activating hall call bypass” may involve activating AS mode (e.g., by driving a high voltage or closing a circuit associated with AS mode activation), even though hall calls may be registered in the call register 335 and/or with an elevator controller or dispatcher. Hall calls may appear on the COP 330 as lighted buttons associated with the floor of the hall call, even though AS mode does not automatically cause the elevator to travel to those floors and respond to the hall calls. Thus, it should be understood that any reference to activating hall call bypass is not limited to only the load weighing system of the elevator, but rather generally refers to any means of preventing the elevator from automatically responding to hall calls.

The sensor module 310 may include a printed circuit board (PCB) 320, which serves as the baseboard on which integrated circuit(s), processor(s), and other electronic components are electrically coupled. The PCB 320 may provide conductive traces that connect the tensor processing unit (TPU) 322, the LEDs 328, the sensor(s) 325, an audio hub/CODEC 326, a serial transceiver 327a, a wireless transceiver 327b (which may be integrated with the PCB 320, or mounted external to the PCB 320), and/or a passive infrared (PIR) sensor 329 (which may be integrated with the PCB 320, or mounted external to the PCB 320) to the system-on-a-module (SoM) 321. Connectors may be coupled to the PCB 320, which provides electrical interfaces to drive the speakers 311a, 311b, the camera module 323, the display module 324, and/or the LEDs 328, among other possible components.

The SoM 321 may include a combination of a central processing unit (CPU) comprising any number of cores, random access memory (RAM), embedded MultiMediaCard (eMMC) storage (or other non-volatile storage), wireless communication radio(s) (e.g., Wi-Fi, Bluetooth, Bluetooth Low Energy (BLE), etc.), a graphics processing unit (GPU) comprising any number of cores, a universal serial bus (USB) controller, an ethernet controller, a video processing unit (VPU), display driving integrated circuit(s), an image signal processor (ISP), cryptographic processor(s), and/or other components to form a computing device or single-board computing (SBC). In some embodiments, the SoM may include thereon the TPU 322 (e.g., coupled to a mini PCI-e bus), while in other embodiments the TPU 322 may be external to the SoM 321 and/or external to the PCB 320 (e.g., a standalone TPU module connected the SoM 321 via USB). Each of the components separate from the SoM 321 may be electrically coupled thereto via one or more PCB traces corresponding to a particular means of communication, such as a UART line, a serial peripheral interface (SPI), an inter-integrated circuit (I2C) bus, a synchronous audio interface (SAI), MIPI CSI, MIPI DSI, and/or general purpose input/output (GPIO) lines, among other possible interfaces or protocols.

The TPU 322 may be any integrated circuit for accelerating the execution of machine learning computational operations. In some implementations, the TPU 322 may be an application-specific integrated circuit (ASIC) that includes arithmetic units (e.g., matrix multiplier units, buffers, activation units, etc.), cores, and/or other processing units for executing commonly used mathematical operations (e.g., pooling, activation, etc.) more quickly and efficiently than more general-purpose processors. In some cases, the TPU 322 may integrate its own on-board memory, which may be flashed or otherwise programmed to store the configuration, weights, and/or hyperparameters of a deep neural network, such that the processing steps to perform an inference on a data sample is predetermined and can be rapidly and repeatably performed thereafter. Such ASIC-based implementations may also be referred to as neural processing units (NPUs) or artificial intelligence (AI) accelerators. In other implementations, the TPU 322 may be a separate co-processor or set of processor cores that incorporate thereon floating point units (FPUs) for accelerating computational steps involving floating point numbers (which are commonly used in deep neural networks). In yet other implementations, the TPU 322 may be a general-purpose processor that includes processing units and dedicated instructions in the instruction set for accelerating the performance of machine learning operations (e.g., RISC-V). In yet further implementations, the TPU 322 may be a field programmable array (FPGA) configured to implement any of the processing devices described above. It will be appreciated that the term “TPU” as used herein generally refers to a processing device for accelerating the performance of machine learning operations on an edge device, and encompasses a variety of potential implementations that vary in speed, power efficiency, and performance.

The sensor(s) 325 may include a combination of transducers, sensors, micro-electrical mechanical system (MEMS) devices, and/or other devices capable of sensing some condition and converting the sensed condition into a current, voltage, or data. In some embodiments, the sensor(s) 325 includes a barometric pressure sensor or altimeter that is operable to detect air pressure or altitude. For example, an altimeter may be implemented by sensing the ambient air pressure (and, in some cases, temperature), and performing a set of mathematical operations based on a known formula to convert that ambient air pressure into an altitude above sea level. In other cases, the barometric pressure sensor may output a voltage, current, and/or data indicative of the ambient air pressure (e.g., in pascals, hecta-pascals, atmospheres, pressure per square inch (PSI), etc.), which can be subsequently converted into an altitude above sea level on in software by the SoM 321. The barometric pressure sensor may preferably have a sensitivity such that the accuracy and precision of the device is sufficient to determine which floor an elevator is nearest to at a given point in time (e.g., for a building with a 3 meter floor-to-floor height, a sensitivity of at least 0.5 meter, preferably less than 0.1 meter to account for noise).

The sensor(s) 325 may also include an accelerometer, gyrometer, inertial measurement unit (IMU), and/or another means for determining linear acceleration and/or angular orientation at a given point in time. For example, an accelerometer (either standalone, or as a part of an IMU) may be used to determine or estimate the kinematic state of the elevator (e.g., position, velocity, acceleration, jerk, etc.). An accelerometer may measure the instantaneous acceleration, which may include acceleration due to gravity, or may subtract out the acceleration due to gravity such that the gravity-independent linear acceleration is determined in 3 dimensions. Some IMUS may incorporate integrated circuits to fuse the measurements from two or more sensor sub-units in order to increase the accuracy or stability of the measurements. Regardless of the particular accelerometer, the sensor(s) 325 may include a sensing device for estimating the instantaneous acceleration of the sensor module 310 (and, in turn, the elevator to which it is rigidly coupled).

The data from two or more of the sensor(s) 325 may be processed, combined, fused, or otherwise input into an algorithm or “tracker” in order to estimate the kinematic state of the elevator with more robustness and/or stability. For instance, an altimeter may be used to measure the position of the elevator (as the elevator travels vertically in one-dimension), while an accelerometer may be used to measure the acceleration of the elevator (e.g., accelerating from a stop, and decelerating as the elevator approaches a destination). The accuracy, precision, and/or noise characteristics may be determined (either based on the manufacturers' data sheets, or by experimentation) and characterized. Then, an algorithm or tracker, such as a Kalman Filter, may be implemented based on the kinematic behavior of an elevator, and based on the accuracy, precision, and noise characteristics of the sensors.

The Kalman Filter or tracker may first receive the measured position and acceleration as detected by the sensor(s) 325. In subsequent time steps, the Kalman Filter or tracker may predict the future position and acceleration (and, in some implementations, velocity) based on the previously measured position and acceleration of the elevator, and based on known noise and sensitivity characteristics of the sensor(s) 325. The position and acceleration may then be measured by the sensor(s) 325, which are provided to the Kalman Filter or tracker to estimate the “true” or filtered position, velocity, and acceleration of the elevator. In this manner, fluctuations due to noise (e.g., gaussian noise, white noise, etc.) may be smoothed out or filtered out, providing a more precise estimate of the elevator's actual position, velocity, and acceleration. Any number of sensors, and any combination of different sensor types, may be used to accomplish the above-described sensor fusion using a Kalman Filter to implement a tracking algorithm.

In various implementations, the sensor module 310 may include an audio hub/CODEC 326 that implements thereon dedicated circuitry for decoding digital audio information in a particular format or encoded using a particular CODEC, performing digital-to-analog conversion (DAC) of digital audio, amplifying the analog audio signal(s), and/or driving the speakers 311a, 311b using the amplified analog audio signals. The audio hub/CODEC 326 may be any suitable means for generating analog audio signals. The speakers 311a, 311b may be any suitable speaker units, transducers, or the like to generate audible sound waves (e.g., chimes, announcements, music, voice, etc.). The sensor module 310 may, for example, generate a sound upon activating hall call bypass, when a threshold occupancy in the elevator is detected, when a threshold occupancy in the elevator is exceeded, etc.

The serial transceiver 327a may be an integrated circuit for converting serial data output from the SoM 321 (e.g., a 0V to 3.3V TTL UART signal) into one or more output signals of a particular serial communication standard, such as RS-232, RS-422, RS-485 (half duplex or full duplex), or CAN bus, among other possible standards. The serial transceiver 327a may, in some cases, include control flow lines, which may be controlled in software to manage the flow of messages on a serial bus (e.g., RTS/CTS), to signal the start and stop of a message (e.g., Xon/Xoff). Although the output wires from the serial transceiver 327a are shown as “A” and “B” lines of a half-duplex RS-485, other protocols or standards may also be used, including full-duplex RS-485 with four output lines (AB and X/Y lines). Full duplex RS-485 may be preferable in implementations where simultaneous two-way communication is desired. In some embodiments, the operating system (OS) running on the SoM may include software for controlling communication with the terminal device server and gateway 351, such as a point-to-point protocol (PPP) daemon on a Linux OS. PPP may be desirable in implementations where the sensor module 310 is to be assigned an internet protocol (IP) address on a local area network (LAN) to, in turn, enable the sensor module 310 to be accessible over a wide area network (WAN), such as the Internet, and thereby be remotely manageable.

Other GPIO lines from the SoM 321 may be provided outside of the sensor module 310 to control the operation of the elevator or other external components or systems. For example, a GPIO output may be provided to a relay which, upon activation, closes a normally-open contact between two wires of an elevator associated with a hall call bypass feature. Although not explicitly shown in FIG. 3, there may be intermediate components between the GPIO output and the elevator, such as opto-isolators, relays, logic converters, voltage converters, and/or other components to convert the GPIO output into a suitable form to be received by the respective component.

The LEDs 328 may be any combination of optical output devices, which may be used to display the status of the device (e.g., whether the device is powered on, whether the device is active, etc.), provide feedback about elevator occupancy (e.g., a color indicating whether the elevator is below, at, or above a threshold occupancy level), and/or otherwise contribute to the aesthetic appeal of the device. In some arrangements, the LEDs 328 may be optically coupled with optical waveguides or “light pipes” that distribute light emitted from the LEDs 328 through various areas of the device.

The wireless transceiver 327b—which may be located on or off the PCB 320—may include an integrated circuit for facilitating wireless communication on one or more electromagnetic frequency bands, using one or more modulation schemes, and/or based on one or more wireless communication protocols or standards. In some examples, the wireless transceiver 327b may facilitate different wireless communication than the wireless radio(s) integrated within the SoM 321. For instance, the wireless transceiver 327b may facilitate wireless telecommunication via a low-power wide-area network (LPWAN), such as LoRa, Sigfox, DASH7, NarrowBand IoT (NB-IoT), Weightless, and/or any other suitable LPWAN standard. In some cases, it may be desirable to equip the sensor module 310 with long range wireless communication that is capable of establishing a wireless connection between the sensor module 310 in an elevator and a gateway located somewhere within the building (e.g., using an LPWAN protocol such as LoRa that has a greater range than common high-speed wireless communication standards, such as Wi-Fi). Depending on the particular environment, wireless communication via the wireless transceiver 327b may be desired where there is limited or no available wiring that might otherwise be used to facilitate wired serial data communication (e.g., where there are no spare wires on an elevator's traveling cable, or where those spare wires are being reserved for alternative uses). The wireless transceiver 327b may be electrically coupled to a suitable antenna to amplify or otherwise increase wireless communication range. The wireless transceiver 327b may additionally and/or alternatively be operable to facilitate wireless communication on other wireless communication networks, such as Zigbee, other IEEE standards, or a proprietary network standard.

In some implementations, the sensor module 310 may include a PIR sensor 329 configured to serve as a low-resolution motion detector. When the sensor module 310 is in an active state, the sensor module 310 may repeatedly perform an event loop or software algorithm that involves computationally-intensive tasks, such as neural network inference (via the TPU 322), video frame processing (e.g., de-distortion, resizing, cropping, background subtraction, etc.), and other subroutines (e.g., two-dimensional object tracking, Kalman filter-based sensor fusion, etc.). These tasks may collectively cause the sensor module 310 to draw and dissipate a substantial amount of power, and might involve reading from and writing to non-volatile flash memory with a finite number of read/write cycles. In order to extend the lifetime of the sensor module 310, the sensor module 310 may be placed into a low power state or “sleep” state during which the device executes instructions at a reduced rate, stops executing one or more subroutines, or suspends performance of one or more operations of the event loop or software algorithm. In this manner, the sensor module 310 may reduce power consumption, reduce the amount of heat generated by the device, and/or reduce the number of read/write cycles performed by the device performed over a given period of time, thereby effectively extending the lifetime of the device. In some embodiments, the sensor module 310 may, upon determining one or more conditions (e.g., no persons being present in the elevator for more than 5 minutes, no movement of the elevator for more than 5 minutes, etc.), enter into a low power state, while activating or keeping active the PIR sensor 329. If movement is detected within the elevator (e.g., the first person in the office in the morning enters the elevator), the PIR sensor 329 senses this movement and causes the sensor module 310 to transition from the low power state to an active state. Thus, the PIR sensor 329 may enable the device to enter and exit a low power state with little to adverse impact on the elevator's operation.

The display module 324 may be similar to or the same as the display module 120 as described above with respect to FIG. 1. The display module 324 may be used to convey information to the passengers within the elevator, such as the number of persons present in the elevator cab. It will be appreciated that the display module 324 may convey a variety of different information for various purposes, not all of which are contemplated explicitly herein.

The camera module 323 may be similar to or the same as the camera module 130 as shown and described with respect to FIG. 1. The camera module 323 may capture images and/or videos at a suitable resolution and framerate in order to achieve the desired performance from the sensor module 310. As one non-limiting example, the camera module 323 may capture video at a resolution of at least 640 by 480 pixels (VGA) at 60 frames per second (FPS) or more. In some implementations, it may be desirable to use a camera module capable of capturing videos at a resolution that matches the image input resolution for a convolutional neural network (CNN), so that CPU and/or GPU time is not spent on resizing an image or video frame. In some embodiments, the camera module 323 may include a wide angle lens or fisheye lens that attaches to a lens mount coupled to an image sensor that enables the image sensor to have a sufficiently wide FOV to capture the entire interior of a particular elevator. In some implementations, the camera module 323 may comprise two or more imagers with non-overlapping or only partially overlapping FOVs, and whose image data is subsequently stitched together to form a continuous panoramic FOV. The camera module 323 may incorporate integrated circuit(s) to control various aspects of the camera module 323 (e.g., exposure, white balance, autofocus, etc.), and/or to perform pre-processing of images (e.g., de-distortion, brightness and/or contrast adjustments, converting to a particular data format, converting the output to a particular camera serial interface, etc.).

One or more different machine learning and/or computer vision techniques may be used to carry out the classification, detection, and/or tracking tasks described herein. “Object detection” models—which includes two-stage detectors (e.g., region-based convolutional neural networks), single stage detectors with anchor boxes (e.g., “You Only Look Once” (YOLO) models based on DarkNet), and single stage detectors without anchor boxes (e.g., MobileNet single shot detector (SSD))—receive input images, extract proposed regions of interest (ultimately becoming the bounding boxes for classified objects), compute feature vectors for each region of interest, and classify each region. Object detection-based may be preferred in implementations where multiple objects are being detected (e.g., multiple person types such as parent and child, other objects such as pets or weapons, etc.). However, object detection-based implementations may exhibit insufficient performance where occlusion is frequent, where objects are only partially present in a video frame, or where artifacts or distortion from a camera lens reduces the confidence interval or otherwise leads to missed detections.

“Image segmentation,” “instance segmentation,” and other segmentation-based models may involve computing a heatmap of likely objects based on one or more features located within a region of an image, and determining a mask or otherwise identifying a group of pixels belonging to a particular object class or a particular instance of an object. While image segmentation may have advantages over object detection in situations where there is significant occlusion and/or partial objects in the frame, some segmentation-based approaches do not reliably delineate between nearby objects of the same class that have directly adjacent pixels. For example, two persons side-by-side or occluding each other may be interpreted as representing a single person, with the region being segmented as a “person” region without determining the number of persons within that region of interest.

“Pose estimation” describes a technique related to segmentation, in which a heatmap of known features of the human body are detected (as “keypoints”), grouped, and ultimately associated with each other as a “skeleton” representation of a person. Pose estimation is advantageous over the other techniques described above in that additional context can be derived about the person's behavior or actions beyond merely locating their bounding box. In addition, interactions between multiple persons may be classified based on the pose keypoint outputs.

However, pose estimation approaches can suffer from false positive detections where one or a few keypoints are detected from other objects in the frame not associated with a person. In addition, due to fluctuations in the confidence interval for each of the keypoints of a detected person, a “bounding box” that encloses all keypoints may rapidly change in size over short time periods which, in turn, can reduce the effectiveness of a tracking algorithm.

As described herein, “object tracking” may refer to any technique in which a previously detected region of interest (of any shape) is matched with a subsequently detected region of interest, such that the two detections are considered to be from the same class, object, or instance across time. In some embodiments, object tracking may involve determining aspects of an object, such as its bounding box's centroid, height, width, and other features, and creating a “tracker” or other structure in memory associated with that detection. Subsequent inferences may be analyzed against these trackers stored in memory, whereby detections are matched to existing trackers based on their size, position, velocity, and other characteristics. One technique involves estimating the position and velocity of a bounding box, predicting the future state of that bounding box, comparing that predicted future state with newly detected bounding boxes, computing a similarity metric between the detected bounding boxes and the tracker-based predictions, and updating the state of each tracker accordingly.

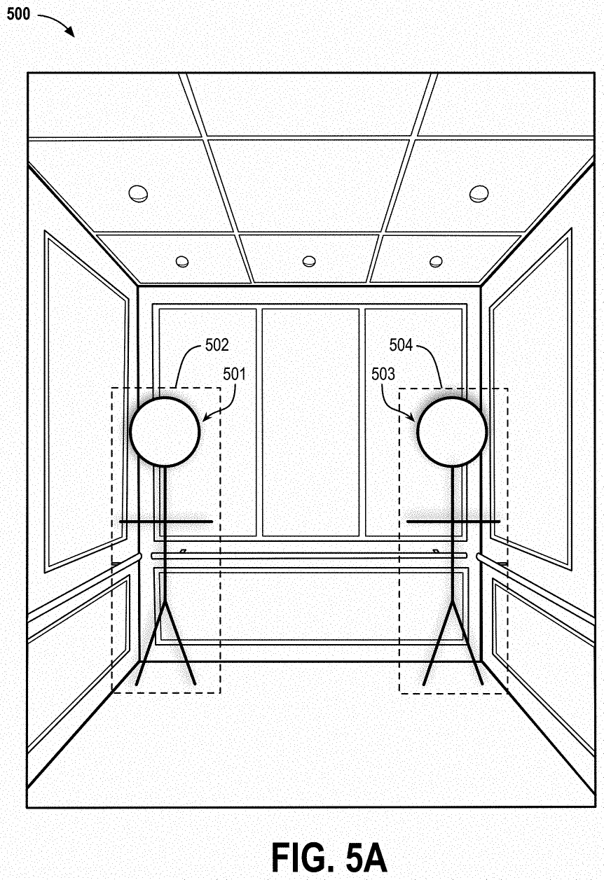

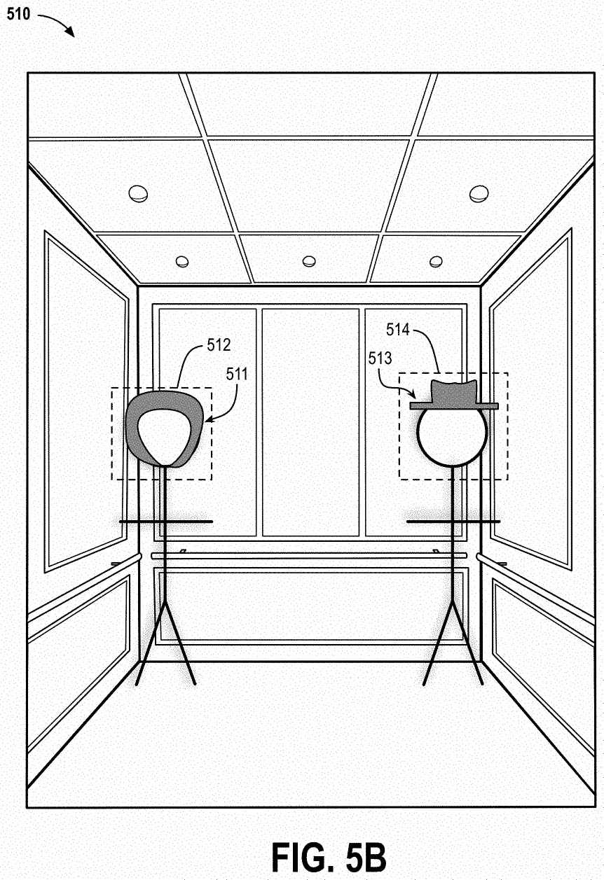

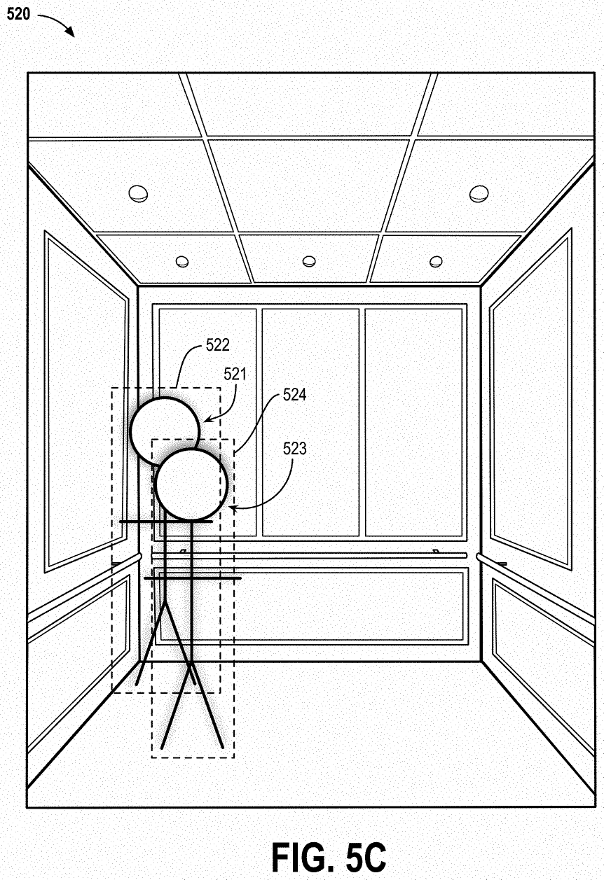

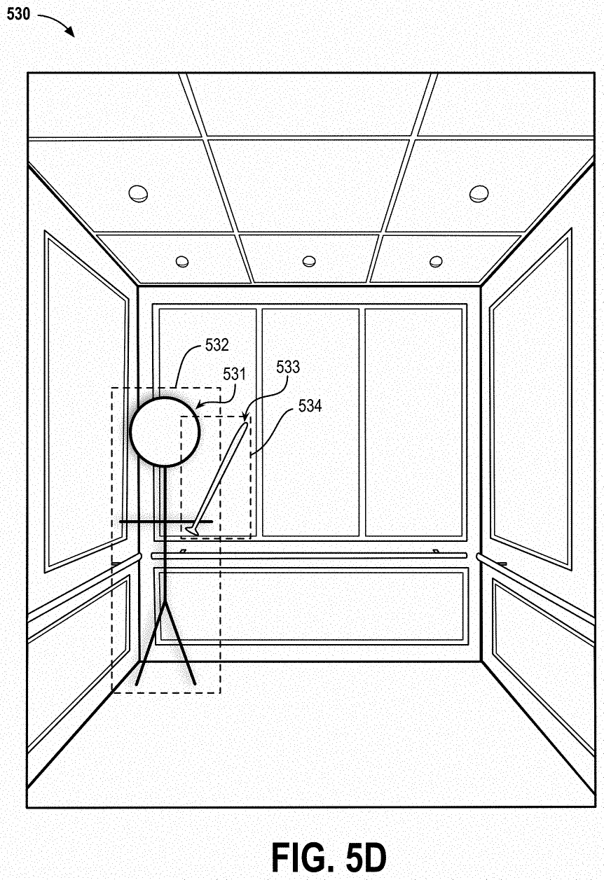

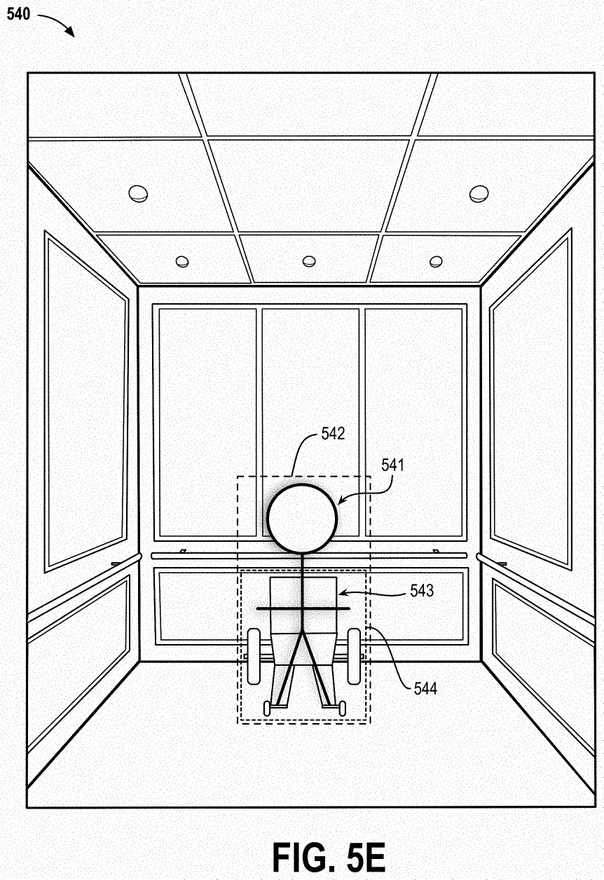

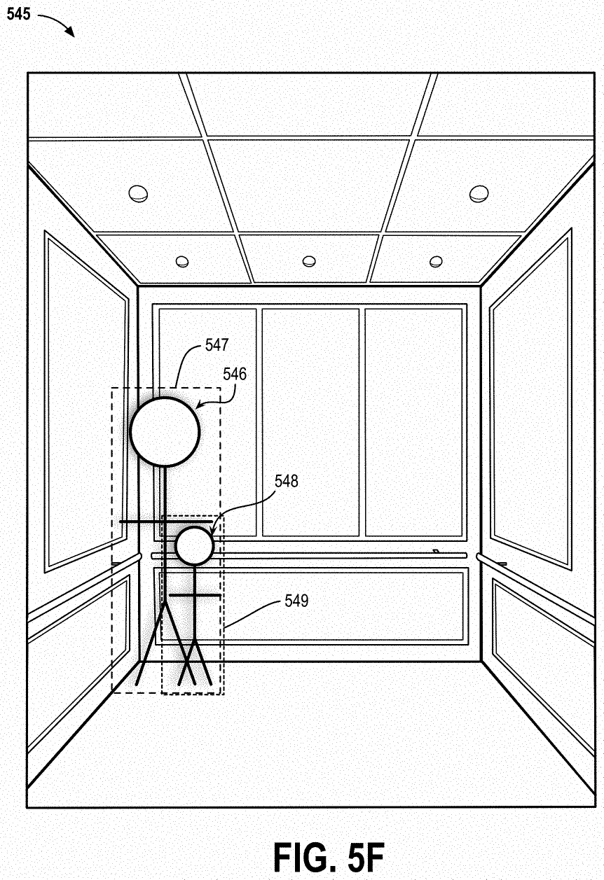

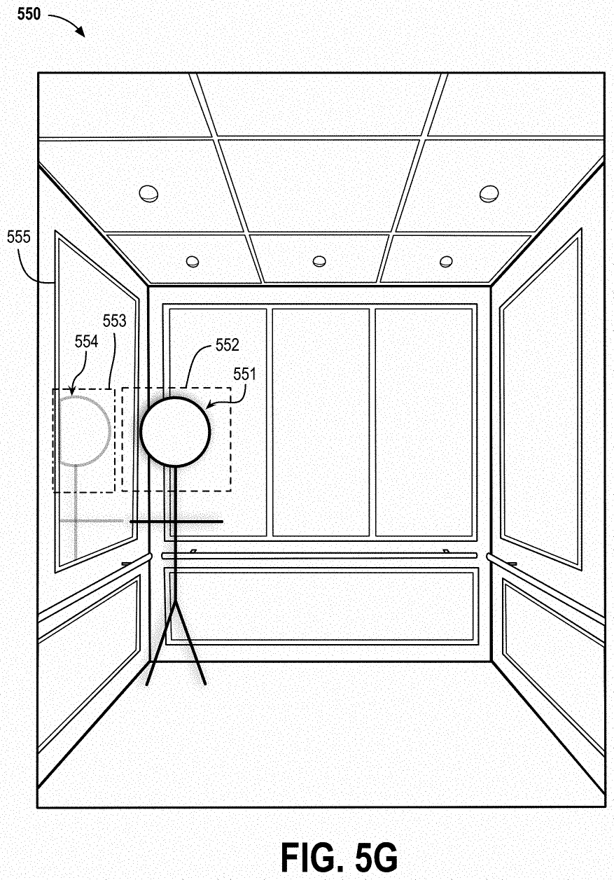

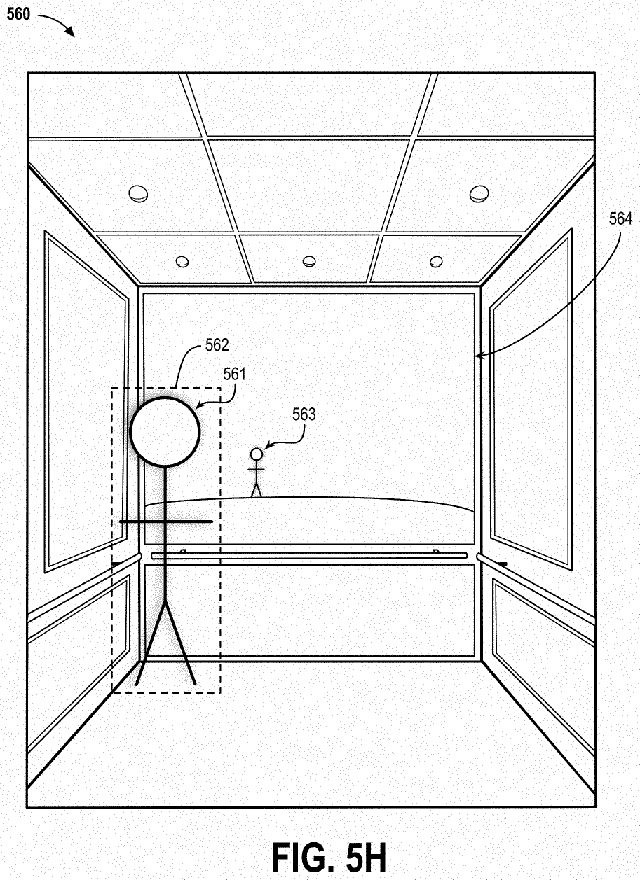

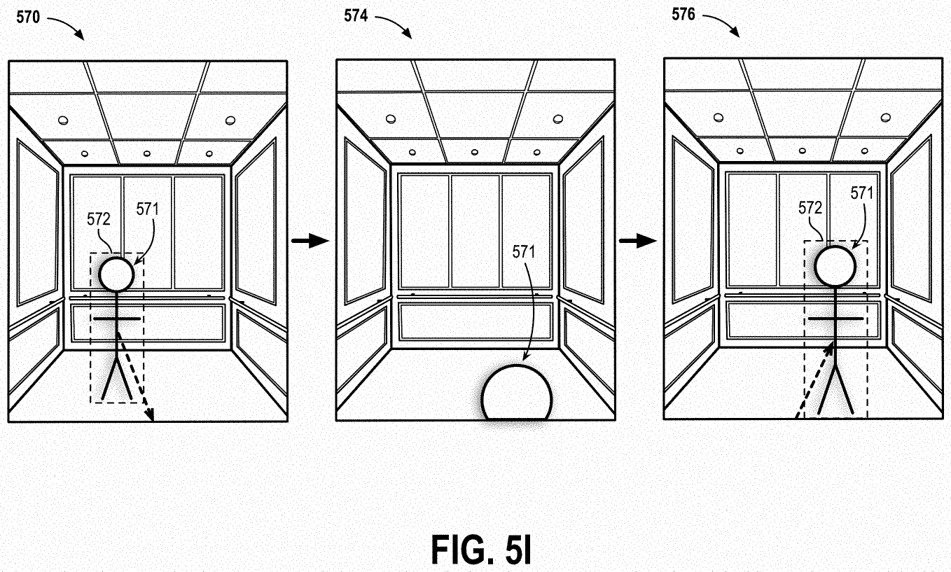

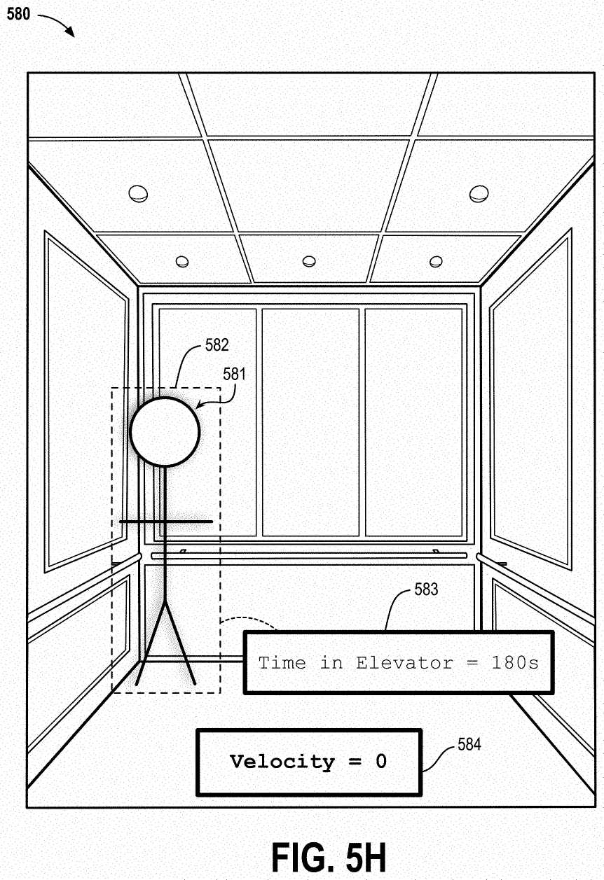

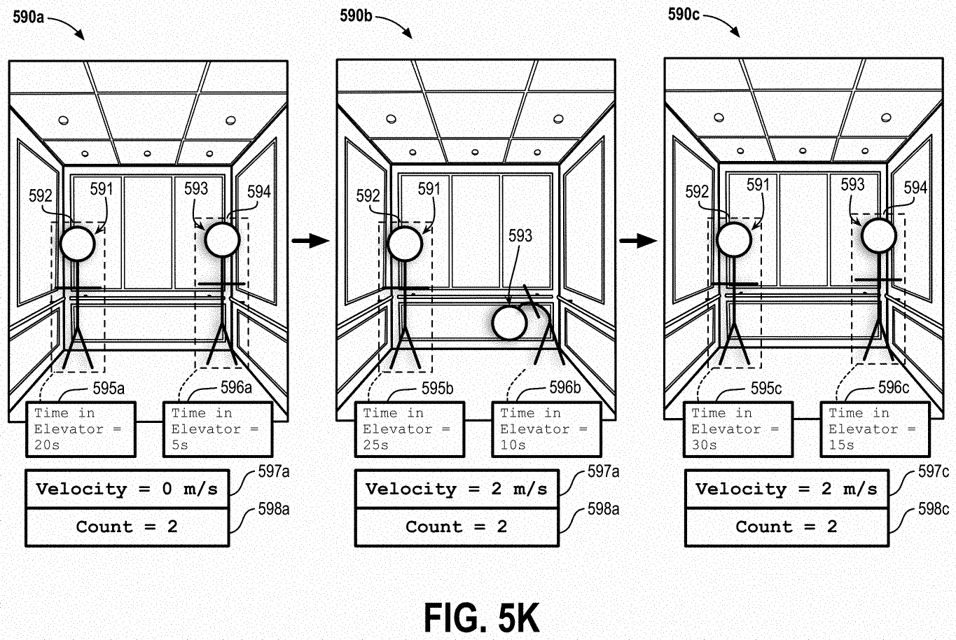

The following description shown and described with respect to FIGS. 5A-5K involve various elevator-specific scenarios. In these examples, one or more of the object detection-, image segmentation-, and pose estimation-based approaches may be described, including how they may be applied in order to perform a particular task or solve a particular problem.

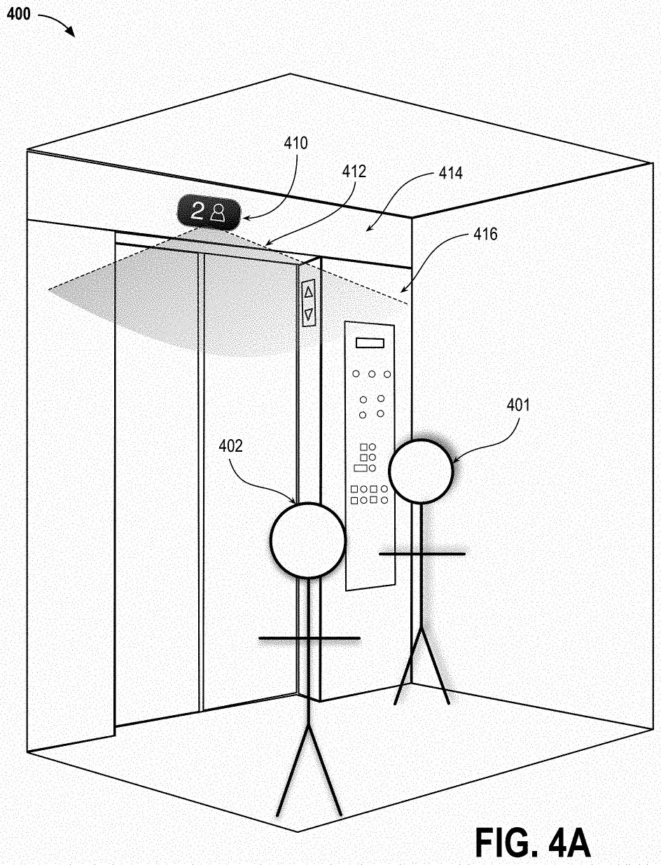

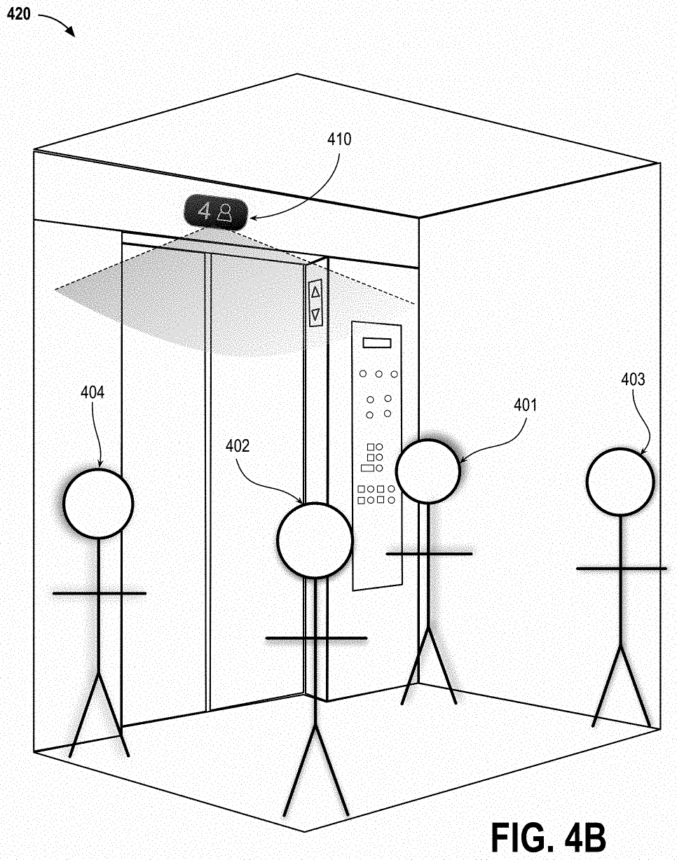

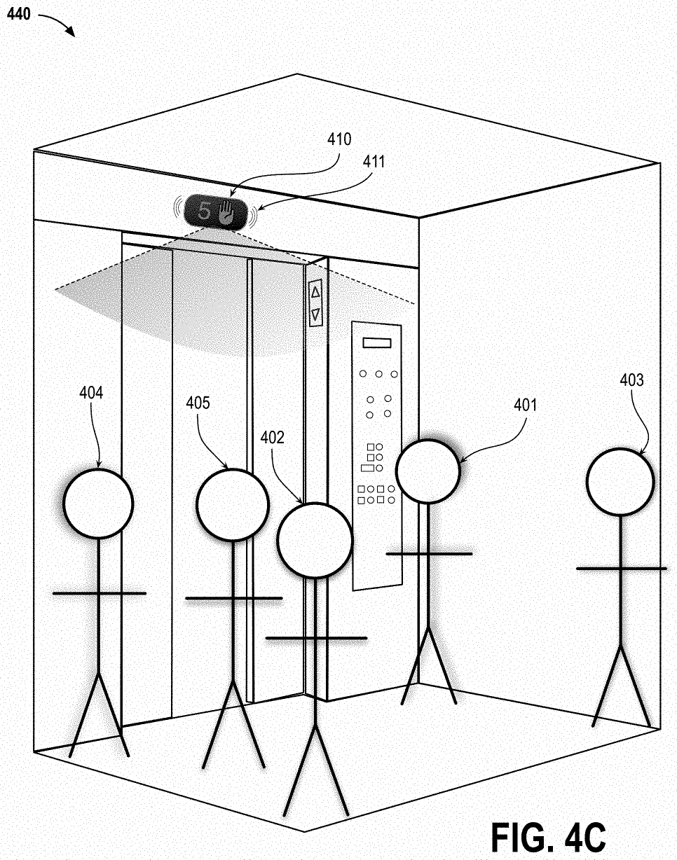

FIGS. 4A-4C depict an elevator interior with a sensor module 410 that is mounted to the front transom panel 414 above the doors 413 of the elevator. The sensor module 410 includes a camera module thereon with a FOV 412 that covers a substantial portion of the interior of the elevator. It will be appreciated that the particular size, angles, shapes, and other details shown in FIGS. 4A-4C may not necessarily be drawn to reflect a particular implementation of the system. For example, the FOV 412 may be wider or narrower than is shown in FIGS. 4A-4C. In these examples, the sensor module 410 may include power and/or data wiring that extends into a space behind the front transom panel 414, with at least some of the wires further extending behind the COP 416 (e.g., where a substantial portion of the electrical wiring is located for the elevator). In some cases, wiring may extend upward to the top of the elevator car (hereinafter, the “car top”), where power and/or data connections may also be present.

As shown in FIG. 4A, the elevator 400 has two persons—person 401, and person 402—present therewithin. In an example procedure, the sensor module 410 performs one or more operations (e.g., object detection, object tracking, image segmentation, pose estimation, etc.) to determine that there are two persons in the elevator. Based on this person count, the sensor module 410 outputs graphics and/or text (e.g., the number “2” and an icon signifying a person) on its display reflecting the number of persons in the elevator. In this example, the color of the graphics and/or text on the display may correspond to a particular capacity “state” of the elevator (e.g., below a threshold capacity (yellow), at a threshold capacity (green), and exceeding a threshold capacity (red)).

As shown in FIG. 4B, the elevator 420 has four persons—persons 401, 402, 403, and 404—present therewithin. In an example procedure, the sensor module 410 performs one or more operations to determine that there are four persons in the elevator. Based on this person count, the sensor module 410 outputs graphics and/or text (e.g., the number “4” and an icon signifying a person) on its display reflecting the number of persons in the elevator. In this example, the color of the graphics and/or text on the display may correspond to a particular capacity “state” of the elevator, such as green indicating that the elevator is at capacity. In some implementations, additional text and/or graphical elements may also be displayed indicating that the elevator is in “bypass mode” or “express mode,” signaling to the passengers that the elevator will not respond to hall calls and will not pick up new passengers before delivering one or more passengers to their respective destination or destinations.

As shown in FIG. 4C, the elevator 440 has five persons—persons 401, 402, 403, 404, and 405—present therewithin. In an example procedure, the sensor module 410 performs one or more operations as described herein to determine that there are five persons in the elevator. Based on this person count, the sensor module 410 may output graphics, text, and/or other visual indications (e.g., the number “5” and an icon signifying a person, and/or an icon indicating that the elevator is above a specified occupancy limit) on its display reflecting the number of persons in the elevator. In this example, the color of the graphics and text on the display may signal to the passengers that an elevator is beyond its designating occupancy limit (e.g., red-color elements) so as to convey to persons 401-405 that the number of persons in the elevator is a health risk. Additionally, the sensor module 410 may emit an audible sound, such as a chime, a warning bell, a spoken message, or the like to inform the persons 401-405 that the occupancy limit is exceeded and requesting that one or more passengers exit the elevator 440. In some embodiments, this message may simply warn the persons 401-405, without the sensor module 410 controlling the elevator differently or otherwise enforcing the occupancy limit (e.g., without holding the door open, without preventing the elevator from moving, etc.). In other embodiments, the warnings may play once, or may repeat some number of times before allowing the elevator 440 to continue operation. In yet other embodiments, the warnings may play continuously until the number of persons in the elevator is at or below a specified threshold occupancy limit. The particular combination of text elements, graphical elements, colors, sounds, and controls may vary among different implementations due to customer preference, applicable laws or regulations, cultural customs, and/or otherwise due to the configuration of the sensor module 410 (with one or more settings being updatable to suit the particular needs of a particular building).

FIGS. 5A-5H illustrate example scenarios that may be encountered by a sensor module, as would be observed from a camera module of the sensor module. It should be understood that the images or video frames shown in FIGS. 5A-5H may not necessarily represent the size, scale, distortion, orientation, angle, and position of a camera module of the sensor module in an elevator. For instance, a given sensor module may be mounted at a high location within the elevator and be aimed downward to extent greater than may be depicted in FIGS. 5A-5H. The example scenarios shown in FIGS. 5A-5H are intended to be used for explanatory purposes only, with the actual shapes, sizes, and features of various objects being drawn to aid in explaining procedures, methods, operations, and techniques of the present disclosure. The following description with respect to FIGS. 5A-5H generally refers to operations performed by a sensor module of the present disclosure, including image and/or video capture by the sensor module's camera module, image and/or video pre-processing, machine learning inference performed by a processor or TPU of the sensor module, and the performance of operations, algorithms, calculations, and/or other instructions based on the images, videos, and/or outputs of the machine learning inference.

With respect to the examples shown in FIGS. 5A-5H, the explicit description of some or all of the steps of a method may be omitted for the purpose of brevity. For instance, a sensor module may cause its camera module to capture a frame and perform pre-processing operations on the frame to produce the frames shown in FIGS. 5A-5H. While the explicit description of such steps may be omitted, it will be understood that any number of operations may occur before or after a given example without departing from the scope of the present application.

As described herein, the terms “image,” “frame,” “video frame,” and the like may generally refer to information or data representative of particular moment in time captured by a camera module of a sensor module. In some cases, the data may be standalone information that can be used to reproduce an image, such as a raw image, a compressed image, an I-frame, etc. In other cases, the data may represent a change in information relative to one or more other images or frames, such as P-frames and B-frames, among other possible video compression frame types. The term “image” as used herein shall generally refer to either a standalone representation of a camera's FOV, or a relative representation of a camera's FOV, and may be used interchangeably with the term “frame.”

FIG. 5A depicts a frame showing an elevator 500 with two persons—person 501 and person 503—standing in adjacent corners of the elevator 500. As shown in FIG. 5A, person 501 may be substantially present within bounding box 502, and person 503 may be substantially present within bounding box 504. The bounding boxes 502, 504 may be determined, in some implementations, using an object detection CNN configured to output coordinates defining the four corners of each respective bounding box. In some cases, the bounding boxes 502, 504 may be determined based on the output of an image segmentation neural network (e.g., by determining the left-most pixels, the right-most pixel(s), the top-most pixel(s), and the bottom-most pixel(s) for a given contiguous region of pixels inferred to be associated with a person). In other implementations, the bounding boxes 502, 504 may be determined based on the output of a pose estimation neural network (e.g., by determining the coordinates of the left-most keypoint, the right-most keypoint, the top-most keypoint, and the bottom-most keypoint, and from those determining the rectangle encompassing all of the keypoints). In yet other example implementations, a sliding window representing a rectangular subset of a frame may be scanned across an image, with each image portion being input into an image classification neural network to predict the class of object (if any) present within that portion of the image, with the bounding box being defined by the coordinates of the sliding window that led to a positive identification of a person within the respective portion of the image. Other implementations are also possible.

In some embodiments, the bounding boxes 502, 504 may be estimated using a tracking algorithm (e.g., Simple Online and Realtime Tracking (SORT), SORT with a deep association metric (“Deep SORT”), a different Kalman filter-based tracking algorithm, a proprietary tracking algorithm, etc.). For example, a detected bounding box (also referred to hereinafter as a “detection”) may be provided as an input into an object tracking algorithm (with the instantiation of a particular object tracker being referred to hereinafter as a “tracker”). The tracker may predict the “state” of an object, such as its position, velocity, acceleration, and other possible attributes based on the previous state of the object, known characteristics about the “noise” or margin of error in the bounding boxes of detections, and the most recently detected bounding box location. In some cases, the tracker may serve to filter or otherwise smooth out small fluctuations in an object's size, position, and velocity, such that intermittent errors such as missed detections, rapid changes in an object's size, bounding box errors arising from object occlusion, and other potential sources of error may be effectively smoothed out. As a result, the bounding boxes of a tracker may generally follow the bounding boxes of detections (e.g., with the tracker's bounding box of an object substantially overlapping a detection's bounding box of that same object), although the precise coordinates of the corners of the tracker's bounding box may not be identical to the coordinates of the respective corners of the detection's bounding box. Some embodiments may not use trackers, while other embodiments may use trackers. Accordingly, as described herein, a “bounding box” may refer to the bounding box of a detection (or the output of processing based on the output of machine learning inference to define a bounding box), or may refer the bounding box of a tracker that is periodically updated based on detections.

Regardless of the particular implementation, the sensor module may determine bounding boxes 502, 504 associated with persons 501, 503, respectively. In the example shown in FIG. 5A, persons 501, 503 do not overlap from the perspective of the sensor module, such that the bounding boxes 502, 504 also do not overlap (e.g., their intersection-over-union (IOU), if calculated, would be equal to zero). In addition, in this example, the method of object detection involves detecting an entire person's body. Detecting a person's body may be advantageous over other methods, as the human body may be visually distinct and may form a sufficiently-sized region of interest (ROI) such that the detection of an entire person (or at least part of a person) may be more consistent in some settings—particularly in scenarios where the substantial majority of a person's body is visible in the FOV of the sensor module's camera module. However, detecting a whole person's body may perform worse compared to other techniques in scenarios where substantial crowding occurs, such that occlusion of one person by another is common, thereby reducing the confidence interval of the detected persons and potentially leading to missed detections.

FIG. 5B depicts a frame showing an elevator 510 with two persons 511, 513 positioned similarly to persons 501, 503 shown in FIG. 5A. In this example, however, persons 511, 513 may be each be wearing headwear or have other objects adorning their heads. An example person counting technique may involve human face or head detection (hereinafter “head detection,” as opposed to “person detection” referring to a means for detecting all of part of a human body), which as described above may be beneficial in scenarios where person occlusion is common (e.g., in part because the IOU of bounding boxes of adjacent persons' heads may be lower than the IOU of bounding boxes of those some adjacent persons' bodies). In some implementations, a head detection model may be trained using example images showing people wearing hats, hoods, jackets, and other head coverings to increase to generality and robustness of the model—such that the model successfully detects the heads of persons 511, 513 shown in FIG. 5B. In general, a model or neural network trained to detect persons may be trained using images in which people are depicted wearing a variety of outputs, with a diverse selection of ethnicities, races, clothing articles, of varying heights, weights, and a variety of other aesthetic qualities, such that the model is robust and able to detect a diverse variety of persons in many different scenarios.

FIG. 5C depicts a frame showing an elevator 520 in which person 523 partially occludes person 521. In some cases, the bounding box 522 of person 521 may be associated with a confidence interval that is lower than the confidence interval associated with the bounding box 524 of person 523. In implementations where a threshold confidence interval is applied to filter out low-confidence detections, such occlusion may lead to person 521 not being detected because the bounding box 522 may have a confidence interval below a specified threshold minimum confidence level. Accordingly, scenarios of person occlusion such as the one shown in FIG. 5C may lead to an inaccurate person count, particularly if the occlusion persists for an extended period of time.

To mitigate this potential issue arising from person occlusion, the present disclosure contemplates the following solutions. For scenarios where occlusion is temporary (e.g., one person walks past another person for a moment), missed detections resulting from occlusion may be smoothed out using object tracking. For instance, if person 523 is walking past person 521 toward the opposite corner of the elevator 520, the tracker for person 521 is stationary while the tracker for person 523 is moving. As person 523 moves past person 521, the tracker for person 521 may persist for some number of times steps, even if the sensor module fails to detect the partially occluded person 521 (with the duration of said tracker persistence being tunable, depending on the particular implementation). As a result, one or more missed detections may not necessarily lead to the loss of the bounding box 522 in embodiments with object tracking. Moreover, because the tracker for person 523 may store the estimated state of the person 523, including the velocity and direction of movement of person 523, a tracking algorithm may not accidentally switch the trackers for persons 521, 523, as the “distance” (e.g., cosine distance or other similarity metric) between the two trackers may be substantial despite having a high IOU value. In other words, object tracking may be sufficiently robust in some embodiments to accurately estimate the bounding boxes 522, 524, despite the occlusion event.

Another example solution to the occlusion problem may involve using image segmentation to differentiate between the contiguous pixels associated with the foreground person 523 and the contiguous pixels associated with the background person 521. Depending on the particular image segmentation model, such differentiation may be possible, such that the pixel group (which is more granular than a bounding box, which contains pixels not representative of a person) may more accurately separate occluded persons.

Yet another example solution to the occlusion problem may involve using pose estimation to differentiate keypoints associated with person 523 from keypoints associated with person 521. An example pose estimation model may involve both identifying said keypoints for each respective person 521, 523, and subsequently associating keypoints with a particular instance of a person. Although person 521 may be partially occluded from person 523, the keypoints that are detected (e.g., the nose, eyes, mouth, left elbow, left hand, left hip, left knee, left foot, etc.) of person 521 may be sufficient to predict the presence of person 521, even though some of the keypoints (e.g., those associated with the right arm and/or right leg) may be occluded. Because pose estimation may be used to detect the presence of body parts separately, pose estimation models may be used to more accurately detect persons during occlusion events.

In some implementations, such as those involving the use of object detection to count the number of persons in a frame, it may be desirable to reduce the minimum threshold confidence interval (e.g., the cutoff confidence percentage below which a potential object is deemed to not be detected) to increase the robustness of person detection, person counting, and/or person tracking. For example, if the minimum confidence threshold is set to 90%, then momentary occlusion of one person by another would likely lead to missed object detections in one or more frames. Because portions of the occluded person may be obscured from view, the confidence interval for a bounding box with a partially-occluded person may temporarily decrease. However, because an elevator is a somewhat controlled environment, it is unlikely that a non-human object would appear in a frame that could be misclassified by an object detection model as a person. Thus, the minimum confidence interval may be set to a lower level (e.g., 60%, among other possible thresholds) such that the momentary occlusion leads to fewer or no missed object detections. In implementations where object tracking is used, fewer missed detections may in turn increase the likelihood that a tracked object is not “forgotten,” and/or increase the likelihood that the tracked object's identity does not switch with the identity of the tracker associated with the occluding person passing in front of the occluded person.

FIG. 5D depicts a frame showing an elevator 530 with a person 531 present therewithin holding a weapon 533. In some embodiments, an object detection model or models may be used to detect not only persons, but also other objects. For example, an object detection model may be trained to detect one or more categories of weapons, such as bats, clubs, crowbars, knives, guns, or other weaponry. An example scenario may involve a person who brings such a weapon into a building, such as under a jacket or in a bag. The person then enters an elevator, intended to travel to a particular floor and inflict harm to one or more persons. While riding the elevator, the person prepares or brandishes the weapon, placing the weapon within view of the camera of the sensor module. Upon detecting the weapon, the sensor module may responsively transmit control signals, activate or deactivate relay(s) or switch(es), and/or otherwise exert control over one or more of the elevator's operations. For example, the sensor module may prevent the elevator from travelling to its destination (e.g., taking the elevator “out of service”). The sensor module may also prevent the doors from opening, thereby temporarily restraining the assailant until law enforcement arrives. Taking the elevator “out of service” may involve activating an emergency mode of the elevator, enabling attendant service (AS) or manual service mode, or otherwise signaling to the elevator (via closed contacts, a voltage signal, a current signal, a PLC signal, a serial data transmission such as CAN bus or RS-485, etc.) to limit elevator operation temporarily. In some implementations, the display module of the sensor module may display graphics and/or texts to convey to the assailant that a weapon was detected and law enforcement is on the way. Images and/or video of the detected weapon and assailant may be captured and stored locally on the sensor module's memory, and/or transmitted to a backend server, which may be subsequently provided to law enforcement or legal teams that prosecute the matter. Although FIG. 5D depicts an assailant holding a bat, a variety of objects may be classified as “weapons” or otherwise prohibited in a particular building, and the object detection model may be trained to detect one or more objects that are classified as “weapons” to suit the particular requirements of a particular building.

In some embodiments, an assailant may be detected using pose estimation. For example, an assailant may be acting aggressively—pacing back and forth in the elevator in an unusual manner, punching at the air, an aggressive stance, moving quickly, etc.—which may be detected by analyzing the patterns in their movement or the nature of the pose(s) (sometimes referred to as “activity recognition”). In these embodiments, aggressive behavior may be detected and flagged as suspicious behavior. In some cases, this aggressive behavior may trigger the sensor module to take the elevator out of service (e.g., if the assailant is alone and not able to harm anyone in the elevator). In another example, pose estimation may be used to detect assault or battery by an assailant to a victim. In that example, the sensor module may capture images and/or videos as evidence of the event, alert building staff of the event, and/or alert law enforcement of the event. An example of a battery event may involve a person raising his/her fist in the air, and moving his/her fist to strike another person—a sequence of events that can be detected using pose estimation, which locates body keypoints such as hands, elbows, head, etc. One or more of these behaviors may be detected, either by a neural network model or algorithmically, triggering one or more actions to be carried out by the sensor module in response.

FIG. 5E depicts a frame showing an elevator 540 with a mobility-impaired person 541 present therewithin. In this example, the mobility-impaired person 541 is sitting in a wheelchair 543. In some implementations, the sensor module may detect the person (as shown by bounding box 542) and the wheelchair (as shown by bounding box 544) separately. Upon detecting the presence of the wheelchair, the sensor module may responsively transmit control signals, activate or deactivate relay(s) or switch(es), and/or otherwise exert control over one or more of the elevator's operations. For example, the sensor module may control the elevator to activate an “express” ride, during which the elevator bypasses any hall calls outside of the elevator and prioritizes delivering the mobility-impaired person 541 to their destination. As another example, the sensor module may deem the mobility-impaired person 541 to count as more than one person (e.g., 2 persons, 3 persons, etc.) for the purposes of limiting elevator occupancy. For instance, if an elevator is limited to 4 persons at a time, and the mobility-impaired person 541 enters the elevator and counts as 3 persons, then only one additional person entering the elevator would trigger an express/bypass mode of the elevator. Other methods of control are also possible.

As described above, detecting a mobility-impaired person may involve detecting the mobility aid (e.g., a wheelchair, cane, walker, etc.) separately from the person using said mobility aid. In other embodiments, however, a person using a mobility aid may be classified as a type of object (for the purposes of object detection), while a person without a mobility aid is classified as a different type of object.

In yet another embodiment, a person with a mobility impairment may be detected based on the nature of their pose using pose estimation. For example, mobility impairment may be inferred if a person is hunched over (e.g., using a walker or a cane), or if a person is sitting (e.g., in a wheelchair). In some cases, mobility impairment may be inferred if the person is laying (e.g., on a stretcher) in hospital or healthcare settings.

In further embodiments, a person with a disability may be detected based on a marker, QR code, or similar visual barcode or pattern that can be detected by the camera module and processed by the sensor module. For example, a person may be particularly vulnerable (physiologically, psychologically, etc.) and request that their elevator rides in a building be given express priority for their health safety. That person may be given a tag, barcode, or other visual code that can be detected by the sensor module and activate an express ride, regardless of their particular pose or presence/absence of any mobility aid.

FIG. 5F depicts a frame showing an elevator 545 with an adult 546 and a child 548 standing near each other. In some cases—such as families that live in an apartment or families staying as guests in a hotel—multiple family members may travel together in an elevator. In some applications, it may be desirable to count not only the number of persons present within the FOV of the camera module, but also determine how many families are present in the elevator. As a specific example, in a hotel setting, a limited elevator occupancy rule may involve limiting the elevator to one or two families at a time, or two persons at a time. In this example, a family of four or five persons may enter the elevator without that elevator being considered “overcrowded” (exceeding a particular occupancy limit). Accordingly, it may be desirable to determine or estimate the number of families present in the elevator, separately from the number of persons in the elevator.

As shown in FIG. 5F, the adult 546 and the child 548 are shown standing directly next to each other, as a parent and child might stand by each other in an elevator. In some embodiments, the distance between the parent and child may be estimated (e.g., the Euclidean distance between the centroids of their respective bounding boxes 547, 549, using 3D pose estimation, determining the overlap or intersection-over-union of their respective bounding boxes 547, 549, etc.). If that distance is below a threshold distance, then the sensor module may determine that the two persons 546, 548 are related, spouses, boyfriend/girlfriend, or otherwise can be designated as a family unit for the purposes of the limited occupancy rule. In some embodiments, the relative sizes of the respective bounding boxes (additionally or alternatively to the distance between the bounding boxes) may be used to classify one bounding box as representing a “parent” and the other representing a “child.” Based at least in part on the size differences of their respective bounding boxes, the sensor module may determine that the two persons represent a family unit. In yet another example, pose estimation may be used to determine aspects of the poses of the respective persons, and may associate particular poses (e.g., holding hands, one person's arms wrapped around another person, etc.) with a personal or familial relationship, and in turn classify the two persons as related for the purposes of the limited occupancy rules.

FIG. 5G depicts a frame showing an elevator 550 that includes a mirror 555 mounted in the cab interior. Some elevators may have therein one or more mirrors or other reflective surfaces, either for aesthetic purposes or for security purposes. Regardless of the reason, reflections may, if left unaccounted for, cause erroneous or duplicate detections to occur for a single object. As an example, a person 551 is standing near the mirror 555 in the elevator 550.

The person's reflection 554 appears in the mirror 555. In this example, the sensor module uses an object detection model configured to detect the heads of persons.

After performing an object detection inference on the scene shown in FIG. 5G, the sensor module determines the presence of a person within bounding box 552, and another person within bounding box 553—despite there being only a single person present in the elevator 550. In order to mitigate this undesirable result, the sensor module may perform one or more operations to determine whether a particular detection is representative of a person, or of a reflection of a person. In some embodiments, a tracking algorithm may be used that involves predicting the future state of a particular bounding box (e.g., using a Kalman filter) and matching these tracked bounding boxes with the bounding boxes of detected objects. Some tracking algorithms may involve further performing a step of feature extraction on the ROI of each bounding box, which generates a feature vector that is descriptive of the contents within the bounding box (e.g., the dominant colors within the box, the shapes present within that box, etc., depending on the particular feature extraction method used). In these embodiments, the feature extractor may generate feature vectors that are the same or highly similar (e.g., a small angle when calculating cosine similarity between the feature vectors) such that the two separate bounding boxes should be deemed as representing a single object. In other words, if the feature vectors extracted from two bounding boxes are highly similar, it is possible or even likely that those two bounding boxes represent the same object in the scene—one for the real object, and the other for the reflection of that object. In the context of person detection, the feature vector may represent visual aspects of the person such as height, body shape, clothing patterns and colors, etc., which distinguish one person from another. In this manner, feature extraction may both enhance the robustness of a tracking algorithm, while simultaneously serving as a means for detecting reflections.

In some embodiments, a separate neural network (e.g., based at least in part on an image classification, image segmentation, or convolutional neural network) may be trained to perform feature extraction for the purposes of enhancing the accuracy of object tracking as described above. For example, a feature extraction network may be trained on a person re-identification dataset, which may be comprised of sets of images—each set containing multiple image segments of the same person captured from different angles and/or different points in time. In some implementations, the sensor module may be configured to capture images and/or videos for the purposes of gathering training data, which may subsequently be labeled manually or via an automated process to generate, among other datasets, a person re-identification dataset. In this manner, feature extraction network may therefore be improved over time.

The feature extraction network described above may be configured to run on the same machine learning accelerator as the object detection neural network, or may be configured to run on a separate machine learning accelerator. It may be desirable to generate the feature extraction model for execution on its own machine learning accelerator to increase the speed at which machine learning inference may occur (e.g., reduce the amount of time it takes to perform feature extraction). By reducing the latency of feature extraction, the computing time required to perform object tracking may thereby be reduced. Reducing object tracking computing time may be desirable to reduce the amount of uncertainty between subsequent frames, as a higher frame rate in effect reduces the distance each bounding box travels within a scene (as less time is elapsed between captured frames).

Another example technique for addressing the reflection issue involves applying pose estimation to determine whether two poses are the same, highly similar, or otherwise transposed (e.g., horizontally or vertically flipped, but otherwise in the same arrangement). Each person's pose includes a set of keypoints that are mapped to parts of the body (e.g., left elbow, right hand, left knee, right eye, etc.) and connected, such that the relative position of a given keypoint to another keypoint of a person is determined. As a result, it can be expected that the detected pose of a person and the detected pose of that person's reflection should match (different orientation, but the same arrangement). In some embodiments, a similarity “score” or other similarity metric may be calculated between two detected poses and, if that score exceeds some threshold, one of the two detections may be deemed a “duplicate” or reflection of the other person.

Yet another example technique for addressing the reflection issue may involve applying image segmentation to determine whether the detected person has a natural shape, or whether that person's shape is truncated or otherwise not visible due to the fact that the reflection is cut off at the edge of the mirror or reflected material. Such a phenomenon is illustrated in FIG. 5G, where the person's reflection 554 is partially cut off on the left and bottom sides due to the limited size of the mirror. In this instance, the segmented region that contains the person's reflection 554 abruptly ends, making an almost rectangular shape on the left and bottom sides of the reflection. This abrupt truncation of the person segment is not present in the segmented portion of the actual person 551, where the whole body is visible with no truncated areas. To the extent that the camera's FOV covers the entire elevator interior (such that a truncated image segment of a person could be attributed to the person being partially outside of the camera's FOV), it can be assumed that such an unusual geometry for a person's image segment is a result of a person's reflection in a mirror. In this manner, reflection detections can be mitigated, and the robustness of the sensor module's people counting capabilities can be improved.

FIG. 5H depicts a frame showing an elevator 560 that is at least partially made of glass or another transparent material, such that regions outside of the elevator cab are visible from within the elevator cab. In such “scenic” elevators, it may be desirable to distinguish objects detected within the elevator cab from objects detected outside of the elevator cab. For example, as shown in FIG. 5H, a person 561 is present in the elevator, and another person 563 is present outside of the elevator (visible through glass 564). If left unmitigated, it is possible that an object detection model might detect both persons 561 and 563, ultimately determining that 2 persons are present in the elevator. To address this issue, one or more heuristics may be applied to the bounding box for each detection to prevent such extraneous detections from incorrectly altering the people count within the elevator. For example, the bounding box for person 563 (not shown) would be substantially smaller than the bounding box 562 of person 561. A minimum bounding box height, width, and/or area may be applied—discarding any bounding boxes below these thresholds—such that the person 563 does not incorrectly contribute to the count of people in the elevator. As another example, the location of the bounding box 563 may be positioned in an unusual location (e.g., “floating” in the center of the elevator), which indicates that the bounding box is associated with a person that is not standing on the floor of the elevator. Accordingly, the lower edge of the bounding box of the person 563 may be present at a vertical location that is above some threshold horizontal line, indicating that it is unlikely that the bounding box is associated with a person present in the elevator. Other heuristics may also be applied.

FIG. 5I depicts a series of frames 570, 574, and 576 showing a person 571 walking out of the camera's FOV, and that same person 571 re-entering the elevator and the camera's FOV. This behavior may occur if the person 571 steps off the elevator to hold the door for someone, or if that person 571 forgot something in their office or apartment. Whatever the reason, it may be desirable to attempt to re-identify that person 571 by maintaining a tracker 572 that persists for some period of time after the person 571 leaves the FOV of the camera (e.g., for 10 seconds, 30 seconds, a minute, etc.). Person re-identification may be advantageous where the sensor module collects data about passenger journey times, or otherwise wants to associate the flow of each passenger from the floor they entered the elevator to the floor they exited the elevator, and estimate the duration of time that the person spent riding the elevator. As mentioned above, a tracking algorithm may involve applying some combination of a Kalman filter and a feature extractor to maintain and update stored trackers which may persist for some limited duration of time after the detected object is “forgotten” (i.e., deemed to be not present in the frame, although the tracker and its metadata may persist beyond this initial “forgetting” stage). For instance, a tracking algorithm may involve (1) predicting the updated location of each tracker in the next frame, (2) detecting one or more bounding boxes of persons present in the camera's FOV, (3) matching each bounding box to a respective tracker, to the extent that any matches exist, and (4) updating the state and metadata of each tracker based on the matches. In step (3) of this algorithm, a feature extraction method, algorithm, or model may be applied to each detected bounding box's region of interest (ROI), which summarizes the contents (e.g., colors, shapes, etc.) of the ROI in a feature vector. By applying feature extraction to each ROI and associating them with a tracker, it is possible to re-identify a person that has left the camera's FOV, and subsequently re-enters the FOV by calculating a similarity metric between the feature vector of the earlier detection (e.g., at frame 570) and the feature vector of the later detection (e.g., at frame 576). If the similarity metric (e.g., cosine similarity) is above a threshold level, the sensor module may determine that the person detected at frame 570 is the same as the person detected at frame 576. And because the person is re-identified, whatever metadata was associated with the person at frame 570 (e.g., total travel time, source floor, etc.) may be applied when that person is re-identified (e.g., the total travel time continues to count up from the previous travel time counter, the destination floor can be associated with the source floor even though the person left and re-entered the elevator temporarily, etc.).

FIG. 5J depicts a frame 580 showing a person 581 in an elevator, along with some metadata associated with that person 581 overlaid as text boxes 583, 584. In some cases, it may be desirable to detect whether a person is trapped in an elevator that is stuck or otherwise out of service, which is typically referred to as an “entrapment” event. By applying object detection, object tracking, and sensor data, the sensor module may infer that an entrapment event is or has occurred. As a specific example, the person's 581 bounding box 582 may have been tracked continuously over the course of 180 seconds (see text box 583), and during this time the velocity of the elevator has remained consistently at or near 0 meters per second (see text box 584). This combination of factors may be considered to be anomalous, as elevator rides typically last for less than a minute and involve the elevator having varying velocities over the course of that journey. But in this example, because the elevator has been motionless and a person appears to be inside the elevator for an extended duration of time (in this example, 3 minutes), it may be inferred that an entrapment event is occurring. In response to detecting the entrapment event, the sensor module and/or an application running on a backend server may notify building staff and/or rescue services of the entrapment event, and provide other relevant data such as the number of people trapped, which elevator they're trapped in, the closest floor that the elevator is stuck at, and/or other information. In this manner, the fusion of object tracking metadata and sensor data may be combined to infer events and allow building management to respond more quickly to those events.

In some cases, a similar technique may be applied to detect if a person is incapacitated in an elevator. For instance, a person may have fainted, passed out, fallen, or is otherwise unable to enter and exit the elevator without assistance. If that has occurred, an entrapment-like event may occur, whereby a person is present in the elevator for an extended period of time, and the elevator doesn't move during that time. Thus, depending on the particular implementation, the sensor module may capture an image of the event, and transmit that image to a backend server, which is subsequently sent to a building manager to assist in classifying the type of event. If the building manager sees that the person is standing and not visible in need of medical assistance, the event may be deemed an entrapment event. If, however, the person is laying, fallen, hunched over, or otherwise appears to be in need of medical assistance, the event may be deemed a medical event. In either case, an appropriate response may be made to address the event.

In some embodiments, the sensor module may determine whether or not a person in the elevator is incapacitated. For example, the person's bounding box may be low to the floor, or otherwise have dimensions that are unlike the dimensions of a bounding box of a person standing upright in the elevator. As another example, pose estimation may be applied, and the person's pose may be analyzed to determine whether they're standing, sitting, or laying down, among other possible poses. Regardless of the particular technique applied, the sensor module may automatically classify whether or not the person appears to require medical assistance, and accordingly classify the anomalous event as either an entrapment (if the person doesn't need medical assistance) or a medical emergency (if the person appears to need medical assistance).

FIG. 5I depicts a series of frames 590a, 590b, and 590c illustrating a sequence of events and a context-based people counting technique and automatic model re-training method. In various embodiments, the accuracy of a particular object detection or other people counting technique may be less than 100%, such that there will be at least some of the time “missed” detections or false negatives (i.e., a person is present, but the object detection method fails to detect them). If left unmitigated, such missed detections could lead to incorrect reporting, data collection, and/or elevator control based on an inaccurate number of persons detected. In most applications, these missed detections can only be verified using human intervention, with an expert observer determining that a detection should have occurred in a particular frame, but did not. However, given the nature of elevator use and operation, some missed detections may be automatically identified (and in some cases ignored for the purposes of elevator control).

In a typical elevator operation, one or more passengers call the elevator using a hall call station. When the elevator arrives, those one or more passengers enter the elevator. Then, the doors close, the elevator accelerates and begins travelling to the next destination. While the elevator is in motion, it is virtually impossible for the number of passengers to change, given that the doors remained closed until the next destination is reached. As such, the present application contemplates that any change in the number of passengers while the elevator is in motion must be due to errors in object detection or tracking, rather than being attributable to an actual change in the number of persons in the elevator.

Based on this realization, the stability and robustness of people counting can be enhanced. As an example, the number of persons may be determined to be 2 (persons 591 and 593, via bounding boxes 592 and 594, respectively) while the elevator is loading (see frame 590a). Then, after the doors close, the elevator accelerates to its travelling velocity. While in transit, one of the passengers bends over, causing the object detection model to “miss” detecting person 593 (see frame 590b). Subsequently, the passenger stands back upright, and the object detection model detects the presence of person 593 again (see frame 590c). Knowing that a passenger could not have exited the elevator while it was in motion, the sensor module determines that the number of persons in the elevator remains at 2 for the duration of the journey (e.g., across the period of time spanning across frames 590a-590c), even though the object detection model failed to detect person 593 while the elevator was in motion. In other words, some embodiments may “lock in” the passenger count, such that control decisions such as hall call bypass do not rapidly or suddenly change while in transit. An example method may involve performing a running average on the number of detected bounding boxes or the number of live trackers, locking in that running average (to the nearest integer) upon detecting a threshold level of acceleration and/or velocity, and maintaining whatever control decision was made based on that locked-in passenger count until a deceleration or slow down is sensed (indicating that the elevator is arriving at its destination).

In addition to stabilizing elevator control and/or dispatch decisions, the above-described context-aware logic can be applied to automatically identify instances where the object detection model failed. For example, at frame 590b, the sensor module assumes that the number of persons (in this case, 2) could not have changed while the elevator was in motion, and responsively saves a copy of the frame 590b and flags it as an example of a missed detection or false negative data sample. However, the missed detection could be due in part because the object detection model being executed on the sensor module is configured to receive a relatively low-resolution image (e.g., 300 pixels by 300 pixels, among other input layer configurations). The copy of the frame 590b that is stored on the sensor module's memory may be at a higher resolution (e.g., the native resolution of the camera module, rather than a downscaled or downsampled image that was provided to the object detection model). After the high-resolution copy of frame 590b is stored, the sensor module may transmit that frame 590b to a backend server. This procedure may be repeated over a period of a day, a week, or some other duration, such that the backend server collects a set of data samples where the currently deployed object detection model failed to accurately identify one or more persons in the frame (or, possibly, erroneously detected a person where none existed).

With these “false negative” data samples, the backend server may input each of them into a comparatively higher resolution object detection model, which could not have otherwise been executed on the sensor module given memory constraints, the need to perform inference in real or near-real time, and/or other processing constraints. In doing so, the backend server automatically generates a set of labeled data samples which correctly labels the bounding boxes of the persons in each image—including persons that were not detected by the deployed object detection model running on the sensor module. Then, the backend server may execute a retraining procedure (e.g., transfer learning) to update the model weights and effectively “teach” the object detection model where it had previously made errors. In other words, the object detection model that was previously deployed on the sensor module may be retrained using automatically labeled data samples on examples that were already known to be points of failure for that model. Once the object detection model's weights have been updated, they may be frozen and the model may be compiled for execution on the sensor module's AI hardware accelerator(s). This updated model may then be pushed as an over-the-air (OTA) update to the sensor module(s) deployed in the field, replacing the previously deployed model with the more accurate version. This entire process may be repeated periodically, such that the object detection model becomes more accurate automatically over time with little to no human intervention or manual labeling, and significantly reducing amount of images or videos that require manual review to spot errors in the model's accuracy.

Accordingly, by applying the context regarding the state of the elevator, certain assumptions can be made when the elevator is in a particular state. For example, during the state of “moving,” the number of people in the elevator simply cannot change. As a result, this error is either due to drift in the accelerometer or barometric pressure sensor (which may be used to estimate velocity) or because the object detection model and/or tracking algorithm mistakenly increased or decreased the count of the number of people. The present application contemplates applying this type of context awareness to other aspects of the sensor module's and/or a server application's operation, such as predicting entrapment events, determining whether a medical emergency is occurring, and/or to otherwise enrich data captured by the sensor module in the course of its operation.

Referring now to FIG. 5K, an example sequence of events is described involving the application of context-awareness to enhance the robustness of elevator control and data collection functions of the sensor module. Frames 590a, 590b, and 590c represent snapshots at specific points in time along said sequence of events. At frame 590a, two persons 591 and 593 have been detected by an object detection model, which generated bounding boxes 592 and 594, respectively. A tracking algorithm has been applied to the bounding boxes 592 and 594, such that person 591 has been determined to have been in the elevator for 20 seconds, while the person 594 has been determined to have been in the elevator for 5 seconds. In addition, at frame 590a, the elevator's velocity 597a is determined to be zero meters per second, and the number of persons detected 598a is determined to be two (based at least in part on the two detected bounding boxes 592 and 594). Frame 590a may be considered as a “loading” or “unloading” state of the elevator, at least while the elevator is stationary.

At frame 590b, the elevator has finished loading and has begun to move toward its next destination. In between frames 590a and 590b, five seconds have passed. During this trip, person 593 bends over (perhaps to stretch, to pick up something they dropped, etc.), causing the object detection model's confidence that person 593 is in fact a “person” object to drop below a threshold minimum confidence level to be considered a positive detection. As a result, the object detection model temporarily “misses” or otherwise fails to detect the presence of person 593 (e.g., because the object detection model was trained with few or no data samples containing persons that are bent over, and as such a person being bent over is not as well-recognized as a person standing upright). However, because the elevator is moving at 2 meters per second (see velocity 597a), sensor module continues to consider the number of persons in the elevator to be 2 (see passenger count 598a)—despite only detecting bounding box 592. In other words, the sensor module assumes that the number of persons present in the elevator does not change while the elevator's velocity is above some threshold value, and/or in between acceleration and deceleration events (implying that the elevator has accelerated to some velocity, and will subsequently decelerate to arrive at the next destination).

In addition, because the sensor module assumes that person 593 has not somehow exited the elevator while it is moving, the sensor module continues to increment the duration that person 593 has been in the elevator. In practice, this may be accomplished by having a tracker object that persists for some period of time after the bounding box associated with that tracker object is not detected, and continuing to increment a duration variable or timer on that tracker of the “forgotten” person even when that person's tracker has not been matched with a corresponding bounding box for some time. In implementations that use feature extraction to perform person re-identification, the tracker may be placed into a dormant state, and “revived” if/when the person 593 is subsequently detected (in part based on the person 593's later bounding box having a feature vector that is highly similar to the previously recorded feature vector of the dormant tracker).

In implementations that do not include feature extraction for person re-identification, a newly-created tracker may be made for person 593 when they are detected again (e.g., as is the case in frame 590c), and that tracker may inherit at least some of the metadata of the previous tracker. For example, if person 593 is associated with a tracker ID of “8” at frame 590a, that tracker ID “8” is associated with a time at which person 593 entered the elevator. That entry time may be inherited by a tracker ID “9” associated with the person 593 at frame 590c, based on the inference that only two people were riding the elevator, and that the forgotten tracker and newly-created tracker likely represent the same object that was temporarily not detected. Regardless of the particular implementation, it will be appreciated that one or more assumptions may be made throughout the course of the sensor module's operation that enables it to algorithmically enhance the robustness and/or stability of the object detection, tracking, data collection, and/or control of the elevator, even if the underlying machine learning tools are inaccurate from time to time.

In a more complex scenario, four persons enter an elevator during a loading event. Before the elevator doors close and the elevator begins to move, the sensor module determines that there are 4 persons present by detecting and tracking four respective person objects. When the sensor module detects a threshold level of acceleration (e.g., at or near the known maximum acceleration of the particular elevator), the sensor module may store a snapshot of the tracker objects and their respective metadata, including their unique identifiers, the duration of each tracker and/or the initial time at which the tracker object was created, any feature values associated with the person contained within each bounding box's ROI, and/or any other metadata. Then, while the elevator is in transit, one or more of the tracker objects are forgotten due to temporary failures to detect the respective one or more persons by the object detection module. When the elevator decelerates and/or arrives at its next destination, the sensor module may compare the current tracker objects with the stored snapshot of the tracker objects from the previous acceleration event and determine whether any of the unique tracker identifiers (also referred to hereinafter as “tracker ID”) in the list of current tracker objects are different and/or missing. If a previously stored tracker ID is absent in the list of current tracker IDs, then the sensor module may determine that one of the current trackers is associated with one of the previously-stored trackers (e.g., if they represent the same person or other object) and accordingly modify the metadata of the corresponding current tracker to inherit at least some of the metadata of the respective previous tracker. Aspects of the current and previous tracker may be taken into account (e.g., the width, height, and/or size of the trackers' bounding boxes, the location of the trackers' bounding boxes, the feature vectors representative of the contents within the trackers' bounding boxes, and/or other factors).

Regardless of the particular technique used to improve the continuity and robustness of data collection related to passenger journeys, the sensor module may apply similar techniques to those described above to likewise improve the stability and robustness of elevator control. For example, the sensor module may “lock in” the person count determined during a loading and/or unloading event upon detecting a threshold acceleration indicating that the elevator has started to move. The number of persons in the elevator may be determined based on the last number of detected persons, a running average of the number of detected persons, the last number of tracked persons, a running average of the number of tracked persons, and/or some combination thereof (in cases where a running average is used, some extent of rounding or truncating of a floating point value to an integer may also be applied). The determined number of persons may then be stored and used as the basis for making one or more control decisions before and/or during the elevator trip. For instance, if the number of persons is determined to be 2 (as in the example of FIG. 5K), and the threshold number of persons permitted to ride the elevator is also 2, then the sensor module may activate a bypass feature of the elevator before, during, or soon after the acceleration event is detected. Even though person 593 is not detected at frame 590b, and the number of detections and/or trackers decreases from 2 to 1, the sensor module may apply the stored number of persons (2) when determining whether to activate/deactivate the hall call bypass elevator feature until a deceleration event is detected by an accelerometer of the sensor module. In other words, the hall call bypass feature of the elevator is not deactivated simply because of a temporary inaccuracy of the object detection model and/or tracking algorithm, based on the assumption that the number of persons in the elevator cannot change while the elevator is in motion (e.g., the ground truth is known based on the context that the elevator is in motion). In this manner, features of the sensor module (such as performing hall call bypass to activate an express ride when elevator occupancy meets or exceeds a threshold occupancy level) may be made more stable in the event of temporary model inference inaccuracies.

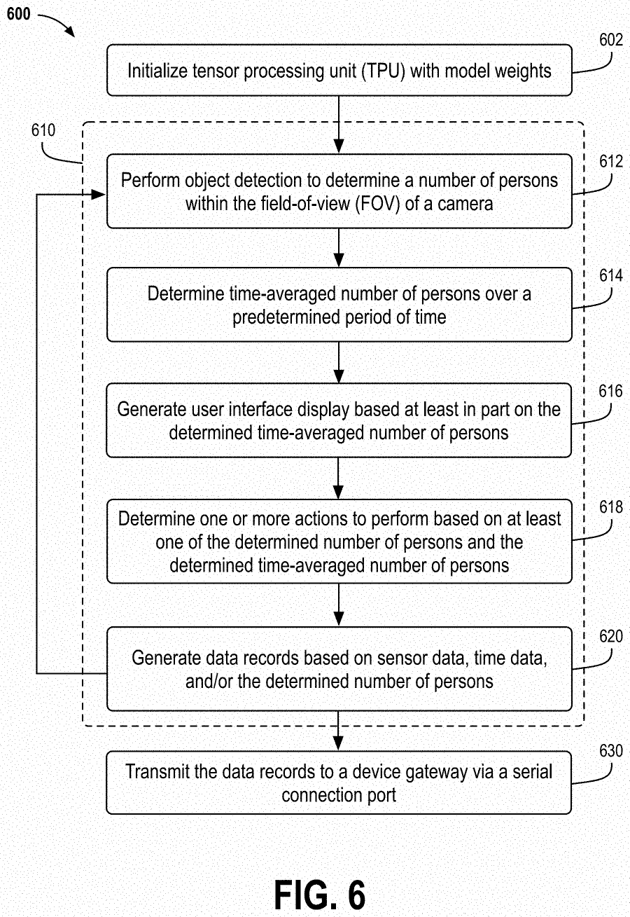

FIG. 6 illustrates a flowchart of an example method 600 performed by an example sensor module according to the present application. As described herein with respect to FIGS. 6-9, aspects of the methods 600-900 may be described as being performed by a sensor module. It should be understood that term “sensor module” refers to any embodiment of the sensor module device as shown and described in the present application. Further, although one or more operations may be described as being performed by the sensor module, it will be appreciated that the operation may be performed by one or more processors of the sensor module, such as a central processing unit (CPU), graphics processing unit (GPU), TPU, and/or other generic or special-purpose integrated circuit.

At block 602, the sensor module initializes a tensor processing unit (TPU) or the like based on model weights, a stored pre-compiled neural network model, and/or any other stored data representative of a pre-trained model executable on the TPU. In an example implementation, the TPU may be configured to receive a pre-compiled model that describes a convolutional neural network's hyperparameters and weights connecting various nodes throughout the model. Upon receipt of the pre-compiled model, the TPU may configure one or more computing elements of the device in order to form a processing pipeline for performing inferences on data samples as described by the pre-compiled model. In some embodiments, two or more TPUs may be integrated within the sensor module, such that block 602 initializing one or more of the TPUs of the sensor module (e.g., a pipelined model broken into two or more sections, multiple independent models, etc.).

At subroutine 610, the sensor module performs an event loop one or more times. The event loop involves, among other operations, executing object detection inference using the TPU, determining the number of persons present within the FOV of a camera module of the sensor module, generating a user interface (UI), determining whether or not to perform one or more actions based on the number of persons in the FOV of the camera module, and generating data records to store information. Each step in the subroutine 610 is explained in more detail below.

At block 612, the sensor module performs object detection to determine a number of persons present within the FOV of a camera of the sensor module. The camera of the sensor module may capture an image or video frame of the interior of an elevator, which may be stored as pixel data in a memory of the sensor module. In some implementations, the pixel data may be processed to change the color space, crop the image, and/or remove or mitigate any distortion caused by a wide-angle or fisheye lens of the camera, among other pre-processing steps. In various embodiments, the stored image data may be resized (e.g., from 640×480 pixels to 300×300 pixels, among other start and end sizes) from a capture resolution to a resolution that matches the input layer of the object detection model. Such a resizing operation may involve maintaining the aspect ratio of the captured image or frame (e.g., by padding the image), or by altering the aspect ratio of the captured image or frame. Regardless, the pre-processed (or not pre-processed) image may be provided as an input to the object detection model executable on the TPU, which performs object detection inference on the image. The TPU may output inference data such as one or more bounding boxes (size, location, etc.), the class of each of those bounding boxes, a confidence interval for each of the bounding boxes, and/or other related metadata.

At block 614, the sensor module determines a time-averaged number of persons over a predetermined period of time. The number of persons detected at block 612 may be appended or prepended to a buffer of a predetermined length (e.g., an array with 20 slots, among other possible lengths). Then, at block 614, a running average may be determined by dividing the sum of the values in the buffer over the length of that buffer. In this manner, the number of persons detected in the frame does not rapidly change over short periods of time (in some cases, the event loop may be executed in under 100 milliseconds, so rapid changes in person count may lead to undesirable control outcomes). In some cases, the running average may be considered to occur over a “predetermined” period of time, even though the execution time of each loop of the event loop may vary (such that the running average occurs over a predetermined number of event loop cycles, instead of a predetermined period of time).

At block 616, the sensor module generates a user interface display based at least in part on the determined time-averaged number of persons. In some embodiments, the time-averaged number of persons may be rounded or truncated to an integer value. This rounded or truncated number of persons in the elevator may be used to generate an output that indicates, at a minimum, a user interface showing the number and an icon or graphic representative of a person. The user interface may include other information as well, such as whether or not the elevator is in bypass mode, the date and/or time, and other text and/or graphics.

At block 618, the sensor module determines one or more actions to perform based on at least one of the determined number of persons and the determined time-averaged number of persons. For example, the sensor module may compare the time-averaged number of persons against a threshold occupancy limit stored in memory and, if the number of persons meets or exceeds the threshold, causes the elevator to activate a hall call bypass mode (e.g., using a pre-existing feature of the elevator used for load weigh bypass, among other possible implementations). As another example, if the sensor module determines that the time-averaged number of persons transitions from at or above the threshold to below the threshold, the sensor module may cause the elevator to deactivate the hall call bypass mode. Other control decisions may involve comparing the time-averaged number of persons against one or more stored thresholds and performing one or more of the following actions: activating or deactivating attendant service mode, holding the doors open, causing the doors to close, taking the elevator out of service, transmitting data to an elevator controller, and/or otherwise generating a voltage, current, activating a switch to influence the operation of one or more features of the elevator.

At block 620, the sensor module generates data records based on sensor data, time data, and/or the determined number of persons. Data records may each be comprised of information about the detected and/or tracked persons (e.g., bounding box locations, duration of each bounding box, the source floor or altitude of each bounding box, the destination floor or altitude of each bounding box, and/or other metadata associated with each bounding box or tracker object), information about the state of the elevator (e.g., altitude, velocity, acceleration, jerk, nearest floor, and/or state of the elevator such as loading, unloading, moving, parked, etc.), and/or other information (e.g., date, time, etc.). These data records may be stored temporarily and/or permanently in memory and/or on a data storage device of the sensor module.

After generating the data records, the method 600 may involve returning to block 612 to restart the event loop. In other instances, the method 600 may involve continuing to block 630, which involves transmitting data to a backend server or other computing device for further storage and processing. In some implementations, the transmission of data records to a server at block 630 may be performed on a separate thread from the subroutine 610, such that the event loop can restart without being substantially delayed by the performance of block 630. In some cases, the data records may be stored in a local memory of the sensor module until they are transmitted to the backend server. In other cases, copies of the data records may be stored in a local memory (for at least some duration of time), which are also transmitted to a backend server for additional processing and storage.

At block 630, the sensor module transmits the data records to a device gateway via a serial connection port. In some implementations, the sensor module may transmit the data records over a wired serial bus, such as RS-232, RS-422, RS-485, CAN, and/or other serial data buses. In other implementations, the sensor module may transmit the data records over a wired data connection, such as an Ethernet connection. In yet other implementations, the sensor module may transmit the data records over a wireless network, such as Wi-Fi, Bluetooth, Bluetooth Low Energy, ZigBee, LoRa, SigFox, or any other suitable wireless communication protocol. In yet further implementations, the sensor module may transmit the data records over a cellular network, such as various 3G networks (e.g., EDGE, GSM, GPRS, HSPA, etc.), various 4G networks (e.g., WiMax, LTE, etc.), various 5G networks, and/or an Internet-of-Things cellular network (e.g., LTE-M, LTE Cat-M1, LTE Cat-M2, LTE NB-IoT, LTE Cat-1, etc.). In some cases, the transmission of data may involve an intermediate gateway device (e.g., a router or gateway), while in other cases the transmission of data may involve transmitting data directly to a network access point (e.g., directly to a cellular tower without an intermediate gateway). Data may be transmitted over any suitable network protocol, such as a REST API or MQTT, among other possible network protocols.

The particular way or ways in which the sensor module transmits data to a backend may depend on the feasibility of each method in a particular building, the ongoing costs involved with a particular method (if any), and/or a variety of other factors. For instance, an elevator system may have spare twisted pairs in a traveling cable which enables the transmission of data between the sensor module and a serial gateway device that is connected to the Internet. However, in some elevator systems there may be no spare twisted pairs, such that a wireless method is preferable to avoid the costs associated with laying new wiring in the traveling cable. In such cases, gateway-based wireless communication may be preferable where the elevator is positioned near the center of the building, and therefore may be out of range of a cellular network. In cases where cellular networks are accessible at the elevator, wireless cellular communication methods may be preferable to minimize the steps involved with the installation of the device.

It will be appreciated that additional operations may be performed in the course of execution of the method 600 beyond those explicitly contemplated in the description above with respect to FIG. 6.

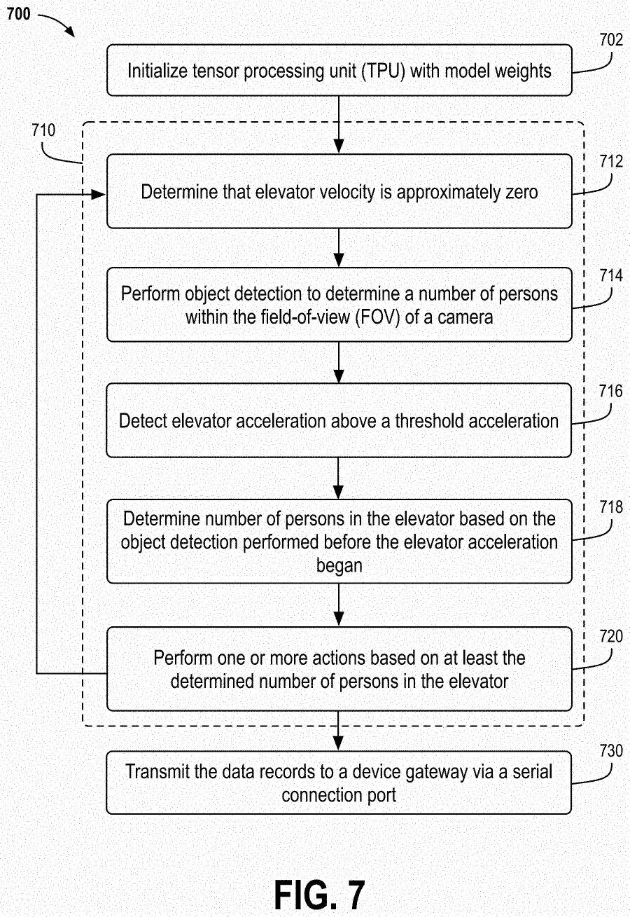

FIG. 7 is a flowchart of an example method 700 performed by an example sensor module according to the present disclosure. With respect to method 700 of FIG. 7, block 702 may be similar to and/or the same as block 602 as described above with respect to method 600 of FIG. 6, block 714 may be similar to and/or the same as block 612 as described above with respect to method 600 of FIG. 6, block 718 may be similar to and/or the same as block 614 as described above with respect to method 600 of FIG. 6, block 718 may be similar to and/or the same as block 614 as described above with respect to method 600 of FIG. 6, and block 730 may be similar to and/or the same as block 630 as described above with respect to method 600 of FIG. 6. Accordingly, further description for each of the above-described blocks is omitted in this section.

Subroutine 710 involves determining the number of persons in the elevator in response to detecting that the acceleration of the elevator exceeds a threshold acceleration. In this example, it is presumed that elevator loading may involve a fluctuating number of persons as people enter and/or exit the elevator. However, once the elevator doors close and it begins moving, the number of persons cannot change until the next stop. As a result, the number of persons in the elevator in this example that is detected soon before the elevator begins to move serves the basis for making subsequent control decisions, mitigating the possibility of an erroneous control decision (or rapidly switching between multiple control decisions) made while elevator occupancy is in flux.

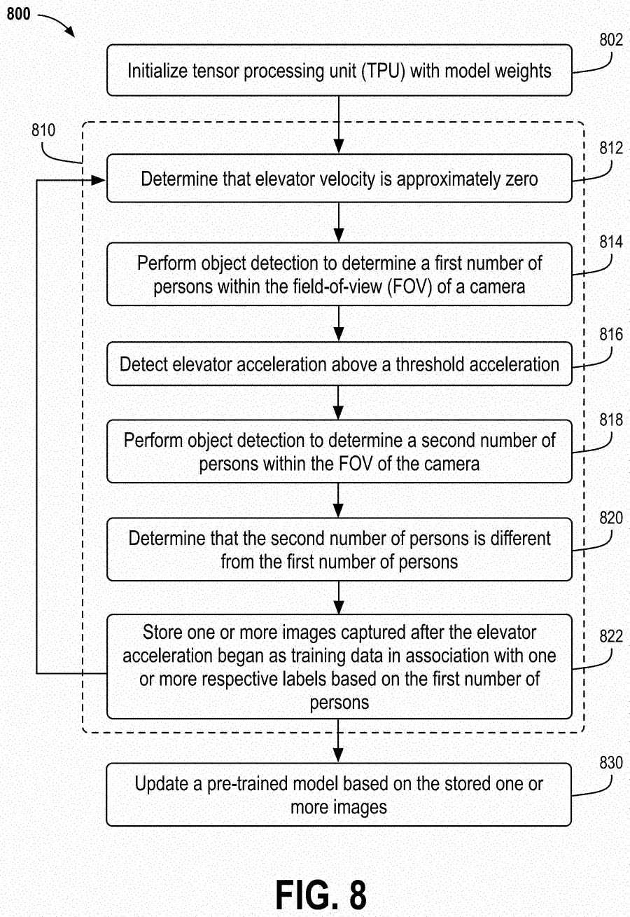

In addition, subroutine 710 encompasses a scenario in which a difference between the number of persons detected before an acceleration event and the number of persons detected after an acceleration event are different and, if so, causing the sensor module to execute one or more operations in response. For example, if the number of persons detected just before and sometime after an acceleration event has occurred differs, the sensor module may store a copy of the frame or frames in which the number of persons detecting while the elevator is in motion differs from the stored number of persons prior to the acceleration event. These stored frames may represent data samples that the object detection model failed to detect, which is automatically determined based on the context of the elevator ride. These stored frames may be transmitted to a backend server which may be labeled (automatically or using manual human review) and used to re-train the weights of the object detection model (e.g., using backpropagation, transfer learning, etc.). This particular example is described in greater detail with respect the method 800 of FIG. 8.

At block 712, the sensor module determines that elevator velocity is approximately zero. As will be appreciated by one of ordinary skill, there are few means for sensing the velocity of an object directly. However, a number of sensing technologies exist for detecting position and acceleration. For example, a rotary encoder may be used to detect the relative position of an object moving along a cable or a wheel. As another example, a barometric pressure sensor may be used to estimate the relative and/or absolute altitude (vertical position) of a device using known formulae (e.g., taking into account the sea level pressure at a particular location which may vary based on the weather). The velocity of the sensor module may be inferred by measuring a change in position of the device over a known period of time. However, estimating velocity in this manner can be inaccurate, depending on the noise profile of the position sensor. For instance, variance in barometric pressure sensor readings may lead to spurious velocity readings that are attributable to random processes or gaussian noise, rather than to actual changes in velocity.

In addition, velocity may be estimated by accumulating or integrating detected acceleration over time from an accelerometer or IMU. However, estimating velocity in this manner can also be inaccurate, both due to gaussian noise in the accelerometer readings, and due to the fact that accelerometer readings are sampled at discrete time intervals, leading to a known phenomenon of sensor “drift” that can occur over time. As a result, inferring velocity from accelerometer readings may be insufficiently accurate for some applications.

As a result, a preferred embodiment of the present disclosure involves estimating velocity based on both the readings from an accelerometer and a position sensor, such as a barometric pressure sensor or altimeter. In an example implementation, a linear Kalman filter may be used to track the altitude, vertical velocity, and vertical acceleration of a device, by modeling the position, velocity, and acceleration kinematics and taking into account the statistical properties of the altimeter and the accelerometer (e.g., the variance or standard deviation of the measurements, the type of noise (e.g., gaussian, brown, etc.) of the measurements, etc.). The Kalman filter may serve to (1) filter out some of noise from the raw accelerometer and altimeter readings, reducing the variance in the tracked altitude and tracked acceleration, and (2) estimate the velocity of the device based on the modeled kinematics of vertical position, velocity, and acceleration.

In an example sensor fusion operation, a Kalman filter object is instantiated and initialized. Then, the current or future state of the altitude, vertical velocity, and vertical acceleration are predicted (based in part on past sensor measurements, and based in part on the process noise characteristics of each of the sensors). Then, the current accelerometer and altimeter sensor readings are used to update the state of the Kalman filter object. This predict-and-update process is repeated, and the resulting tracked altitude, tracked vertical velocity, and tracked vertical acceleration are updated after each sensor measurement. In various embodiments described herein, the tracked altitude, tracked vertical velocity, and/or tracked vertical acceleration may be used for various processes of the present application instead of direct readings from an accelerometer, altimeter, or other sensor.

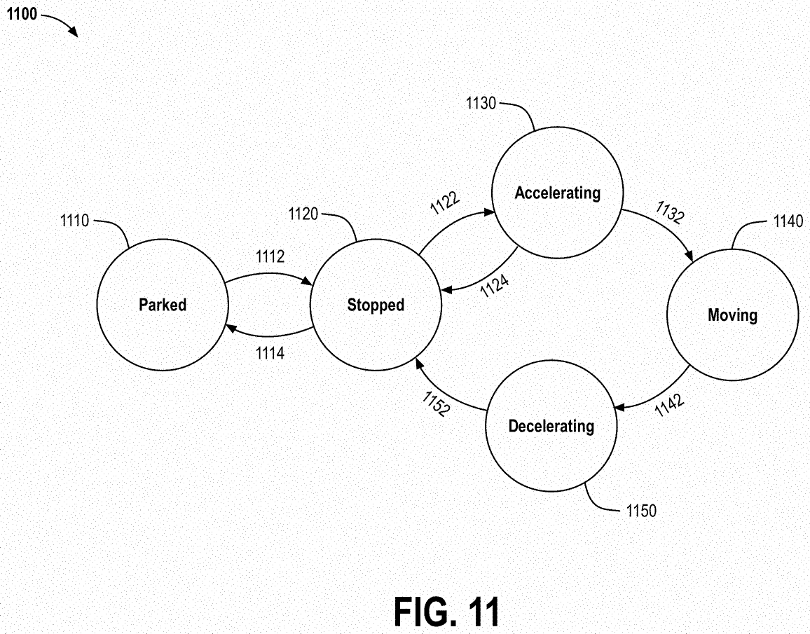

In some implementations, a state machine may be implemented to monitor the kinematic state of the elevator. An example state machine 1100 is described herein in greater detail with respect to FIG. 11.

With respect to block 712, determining that the elevator's velocity is approximately zero may involve estimating velocity using one or more of the techniques described above, and determining whether that estimated velocity is below or within some threshold. As a specific non-limiting example, if the absolute value of the sensed or tracked vertical velocity is less than 0.1, then the velocity of the elevator is determined to be approximately zero. Even in implementations that use Kalman filtering or other filtering or smoothing algorithms, the velocity readings may still not be exactly zero while the elevator is motion. Thus, determining that an elevator's velocity is zero may generally involve estimating that the velocity is approximately zero in this manner.

At block 716, the sensor module detects an elevator acceleration that is above a threshold acceleration. Block 716 may involve reading an accelerometer or the like and using that raw sensor reading, or updating a Kalman filter tracker to determine the tracked acceleration of the device. The threshold acceleration may be set based on a known acceleration or jerk profile of the elevator (e.g., if the maximum acceleration of an elevator is 1 m/s, then threshold may be at or near 1 m/s).

At block 720, the sensor module performs one or more actions based on at least the determined number of persons in the elevator. If the sensor module determines that the number of persons detected at block 714 is different from the number of persons detected at block 718, the sensor module may store a copy of the image or video frame. Alternatively or additionally, block 720 may involve performing or suppressing the performance of a particular action, such as maintaining a hall call bypass activation or not deactivating a hall call bypass feature (if one or more persons are temporarily missed by the object detection model), or not activating a hall call bypass feature of the elevator (if a spurious bounding box or boxes are detected that might cause the person count to exceed a threshold).

FIG. 8 is a flowchart of an example method performed by the example sensor module, according to an example embodiment of the present disclosure. With respect to method 800 of FIG. 8, block 802 may be similar to and/or the same as block 602 as described above with respect to method 600 of FIG. 6, block 812 may be similar to and/or the same as block 712 as described above with respect to method 700 of FIG. 7, block 814 may be similar to and/or the same as block 612 as described above with respect to method 600 of FIG. 6, and block 816 may be similar to and/or the same as block 716 as described above with respect to method 700 of FIG. 7. Accordingly, further description for each of the above-described blocks is omitted in this section.

At block 818, the sensor module performs object detection to determine a second number of persons within the FOV of the camera. Determining the second number of persons may involve similar operations as people counting techniques described herein. At block 820, the sensor module determines that the second number of persons is different from the first number of persons.

At block 822, the sensor module stores one or more images captured after the elevator acceleration began as training data in association with one or more respective labels based on the first number of persons. The one or more respective labels may include the expected number of persons in the one or more images, the detected number of persons in the one or more images, and/or bounding box information for the detected person in the one or more images. The stored one or more images and associated labels may be transmitted to a backend server to re-train or otherwise update an object detection model to improve its accuracy.

At block 830, a computing device, server, or cloud application updates a pre-trained model based on the stored one or more images. Prior to block 830, the sensor module may transmit the stored training data to the computing device, server, or cloud application. Then, at block 830, the computing device, server, or cloud application may perform object detection inference using a higher-resolution object detection model (relative to the model executing on the sensor module), which identifies one or more persons in each of the images that were missed by the object detection model running on the sensor module. With the “missed” detections now properly identified, the training samples may be transformed to an appropriate resolution and used to re-train (e.g., using transfer learning) a pre-trained model. The updated model may subsequently be compiled for execution on the sensor module's TPU, and transmitted to one or more sensor modules to replace the existing models in each of their respective memories.

In this manner, the object detection model's mean accuracy precision (mAP) may automatically improve over time, with little to no human intervention. The method 800 may be carried out with a plurality of sensor modules deployed in various elevators, which collect training data automatically during the course of operation and transmit that training data to a backend server on a regular basis. That training data may be collected at a backend server, automatically labeled, and used to retrain an object detection model. This retrained model may then be pushed to the plurality of sensor modules as an OTA update, improving the accuracy of each of the deployed sensor modules in subsequent operation.

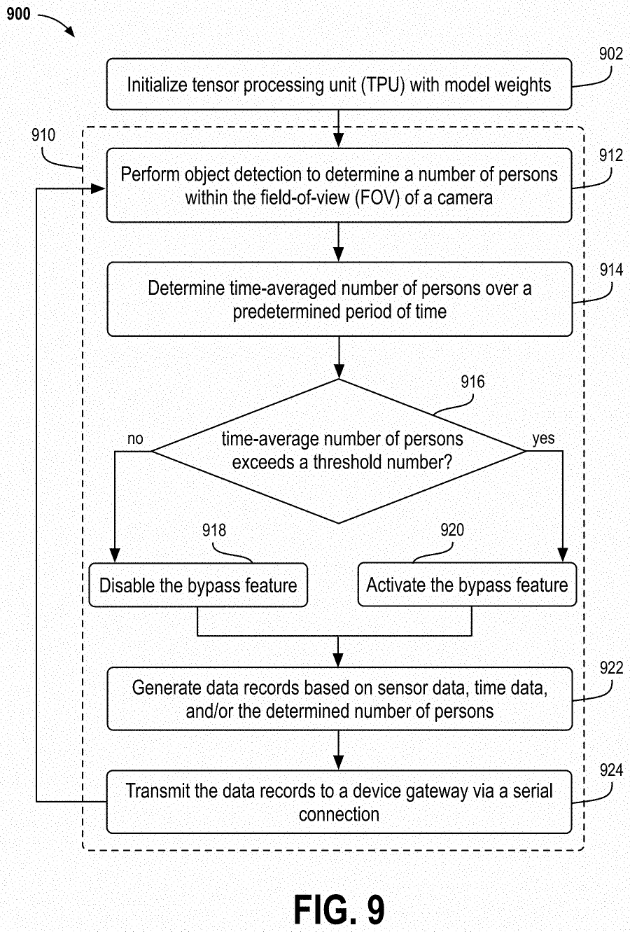

FIG. 9 is a flowchart of an example method performed by the example sensor module, according to an example embodiment of the present disclosure. With respect to method 900 of FIG. 9, block 902 may be similar to and/or the same as block 602 as described above with respect to method 600 of FIG. 6, block 912 may be similar to and/or the same as block 612 as described above with respect to method 600 of FIG. 6, block 914 may be similar to and/or the same as block 614 as described above with respect to method 600 of FIG. 6, block 922 may be similar to and/or the same as block 620 as described above with respect to method 600 of FIG. 6, and block 924 may be similar to and/or the same as block 630 as described above with respect to method 600 of FIG. 6. Accordingly, further description for each of the above-described blocks is omitted in this section.

Decision 916 and outcomes 918 and 920 are an example implementation of block 618 described above with respect to FIG. 6. In this example, the sensor module determines whether the time-averaged number of persons exceeds a threshold number at block 916. If the time-averaged number of persons does not exceed the threshold number, the sensor module disables (or otherwise does not enable) a hall call bypass feature of the elevator at block 918. If the time-averaged number of persons does exceed the threshold number, the sensor module enables (or otherwise does not disable) the hall call bypass feature of the elevator at block 920. In this manner, the elevator does not respond to hall calls when an elevator is at or above a designated occupancy limit, instead travelling to the next destination of the passenger(s) inside the elevator. Once the number of persons in the elevator has dropped below the threshold, the bypass feature is deactivated, allowing the elevator to once again respond to hall calls.

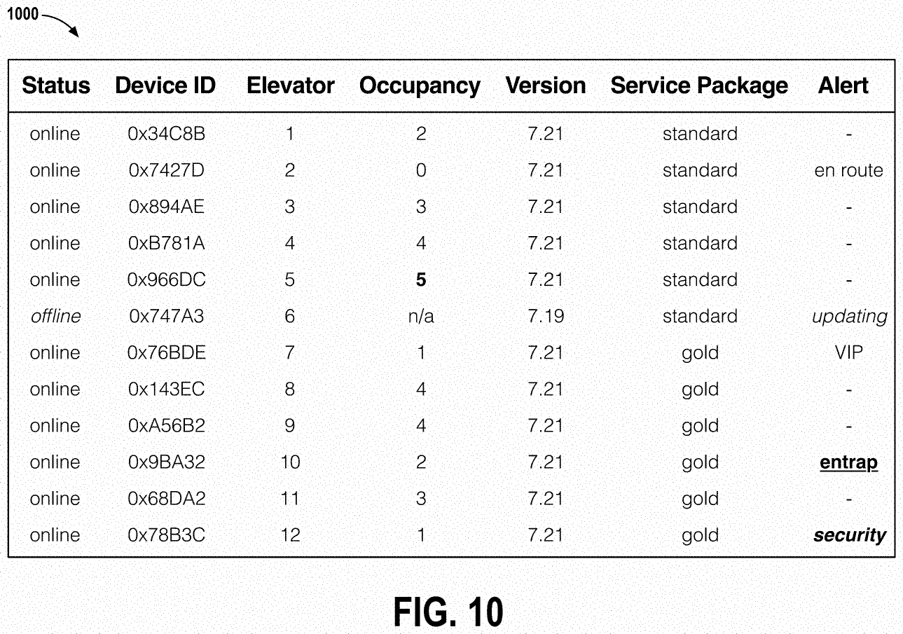

FIG. 10 is an example management user interface 1000 for managing a plurality of elevators, according to an example embodiment of the present disclosure. As shown in FIG. 10, the UI includes an entry for each of twelve elevators in a building. For each elevator, the UI displays the status of its sensor module, an ID of each sensor module, which elevator it is, how many persons were most recently detected to be in the elevator, the version of the software running on the sensor module, the service package level associated with the elevator's sensor module, and any notifications or alerts related to that sensor module.

In some implementations, multiple service package tiers may be specified that provide different features for a sensor module. For example, a “gold” level service package may include features such as automatic entrapment detection, security features such as weapon detection, and/or other features not provided with the “standard” level service package. Some of these features may involve some combination of software running on the sensor module, and/or a processing pipeline on a backend server or cloud application.

In various implementations, one or more alerts may be generated by a server or application in response to detecting certain events or anomalies. For example, an alert of “VIP” may be generated if a particular person designated as a VIP enters the elevator, triggering an express ride. As another example, an alert of “entrap” may be generated if the elevator detects that a person is trapped in a stuck elevator. As yet another example, an alert of “security” may be generated if there is a security threat, such as a dangerous person or someone carrying a weapon, detected in the elevator. Other alerts are also possible.

FIG. 11 illustrates an example state machine 1100 for determining the kinematic state of an elevator, according to an example embodiment of the present disclosure. More particularly, the state machine 1100 is adapted to minimize the likelihood of detecting an elevator trip that did not actually occur (e.g., due to sensor noise). The state of the state machine 1100 may be updated based on raw sensor measurements, Kalman-filtered sensor measurements, detected persons, and/or tracked persons, among other possible input variables.

The state machine 1100 includes a Parked state 1110, in which the state machine 1100 is initialized. The Parked state 1110 may refer to the state of an elevator that has been motionless (and, in some cases, unoccupied) for some threshold duration of time (e.g., 30 seconds, among other time thresholds). Transition 1112 may trigger in response to the number of detected persons (or tracked persons) increasing from zero to a positive number (e.g., one or more persons detected or tracked). Transition 1112 may also trigger in response to a threshold level of acceleration (or Kalman-filtered acceleration) being detected due to the pull from the elevator motor beginning to move the elevator in response to a hall call. The duration in which the elevator is in the Parked state 1110 (as compared to other states) may be desirable to track as a metric of the level of “utilization” of that elevator over a given period of time. For example, if an elevator spends 6 hours of a day in the Parked state 1110, then the elevator may be considered to be 75% utilized over that time period. Measuring the level of utilization of an elevator may be desirable to determine how frequently the elevator should be serviced, and/or to determine whether upgrades to the elevator should be made to alleviate potential wait times for the elevator, among other possible applications.

The state machine 1100 also includes a Stopped state 1120, which may represent that the elevator is not in motion but is current loading passengers, unloading passengers, recently loaded or unloaded passengers, and/or recently moved from one landing to another. The transition 1114 back to the Parked state 1110 may be triggered if no persons are detected (or tracked) and the elevator has not moved continuously for a threshold duration of time. Transition 1122 to the Accelerating state 1130 may be triggered upon measuring acceleration that exceeds some threshold level of acceleration (e.g., 0.5 m/s^2, among other possible acceleration thresholds).

The state machine 1100 also includes an Accelerating state 1130, which may represent that the elevator is currently undergoing acceleration, but not yet moving at a steady-state speed. The transition 1124 back to the Stopped state 1120 may be provided for primarily to prevent the state machine 1100 from getting stuck in the Accelerating state 1130, such as if the elevator suddenly jerks and triggers transition 1122, but does not actually begin a trip where it would be moving at a substantially high velocity. Once the elevator accelerates up to a threshold velocity (e.g., 0.8 m/s, among other possible velocity thresholds), the transition 1132 to the Moving state 1140 may be triggered.

The Accelerating state 1130 may be provided between the Stopped state 1120 and the Moving state 1140 primarily to prevent the state machine 1100 from rapidly switching between the Moving state 1140 and the Stopped state 1120 due to sensor noise. Although Kalman filtering may dampen noise from raw sensor measurements, there still exists a non-zero level of sensor noise measurable in the Kalman-filtered estimates of altitude, velocity, and acceleration. By providing an intermediate Accelerating state 1130, one transition (transition 1132) may be used to determine that an elevator trip is occurring. In this manner, the likelihood of detecting spurious elevator trips is significantly reduced.

The state machine 1100 also includes a Moving state 1140, which may represent that the elevator is moving at a substantially steady-state velocity in the hoistway. The transition 1142 to the Decelerating state 1150 may be triggered in response to detecting acceleration that exceeds a threshold value, but with the opposite sign of the acceleration that caused the state machine 1100 to transition from the Stopped state 1120 to the Accelerating state 1130. In some implementations, the state machine 1100 may record the direction of acceleration (e.g., up or down), such that the transition 1142 is triggered upon detecting a threshold level of acceleration in the opposite direction of that which caused the state machine 1100 to transition to the Accelerating state 1130. In this manner, the likelihood of spurious triggers of the transition 1142 may be reduced.

The state machine 1100 further includes a Decelerating state 1150, which may represent that the elevator has begun to slow down and is approaching a landing. The transition 1152 back to the Stopped state 1120 may be triggered upon detecting a drop in the measured or Kalman-filtered acceleration below a threshold level of acceleration.

The state machine 1100 may be used to detect the occurrence of elevator trips. In an example embodiment, an elevator trip may be provisionally deemed to begin at transition 1122. If transition 1124 is triggered, that elevator trip is discarded. However, if transition 1132 is triggered, the elevator trip is deemed to have begun. The elevator trip may be considered to continue until the state machine 1100 moves along transition 1152 and returns to the Stopped state 1120. Metadata about the trips (e.g., starting time, ending time, starting altitude, ending altitude, peak acceleration, peak velocity, peak deceleration, etc.) may be stored in memory and subsequently transmitted to a server after the elevator trip is completed.

It will be appreciated that the acceleration and velocity thresholds for transitions 1122, 1124, 1132, 1142, and 1152 may vary among different implementations, for at least the reason that there exist a variety of types of elevators that accelerate at different levels and travel at different steady-state velocities.

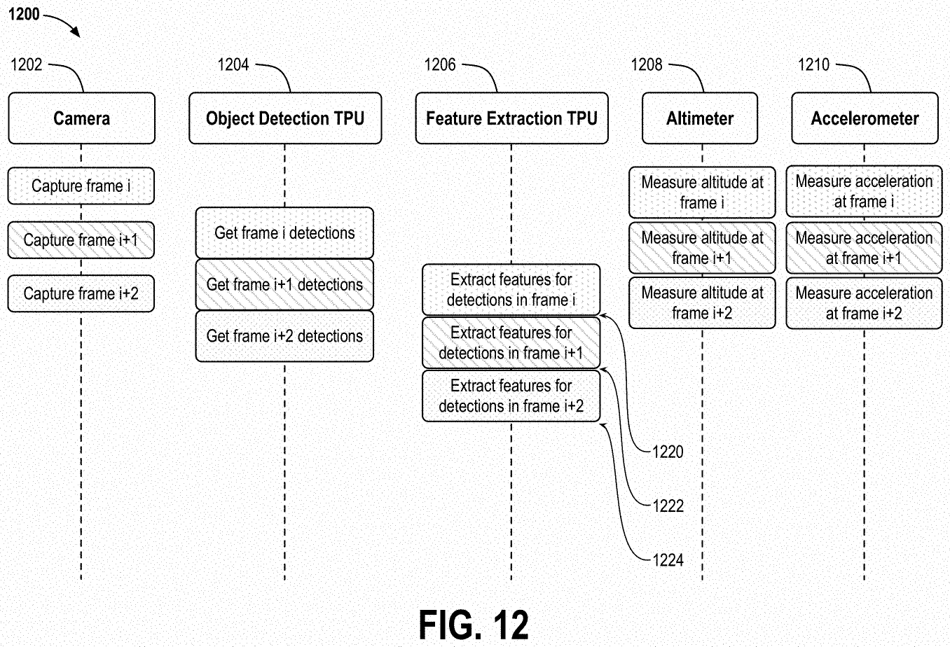

FIG. 12 is an example timing diagram 1200 of an example concurrent pipeline optimization, according to an example embodiment of the present disclosure. The techniques disclosed herein may involve getting data from (and/or transmitting data to) multiple input/output (I/O) devices. A typical event loop of the present disclosure might involve capturing a camera frame, performing object detection inference on that frame, performing object tracking based on the detections, measuring acceleration, and measuring altitude—and then repeating the entire loop by capturing the next camera frame. However, the present application includes the realization that a significant amount of processor time is spent waiting for I/O devices to complete their respective tasks. For example, retrieving a camera frame via USB might take 5 to 10 milliseconds on average, performing object detection on a TPU might take 20-30 milliseconds on average, performing feature extraction in support of an object tracking algorithm on another TPU might take 5-20 milliseconds on average, and retrieving sensor data from the altimeter and accelerometer (e.g., via an I2C or SPI bus) might each take 5-10 milliseconds. It is therefore highly inefficient to perform each of these I/O tasks sequentially.

An example optimization involves providing program instructions to a processor to begin multiple I/O tasks simultaneously in order to reduce processor downtime and effectively increase the “framerate” or execution frequency of an event loop. Whereas a sequentially-executed event loop might take anywhere from 40-80 milliseconds to complete, for example, performing multiple I/O operations simultaneously may be used to reduce the event loop execution time substantially.

As shown in FIG. 12, the camera 1202 begins by initiating the capturing frame i in parallel with the reading of the altimeter 1208 and the accelerometer 1210. Once the initial frame is returned from the camera 1202 to the CPU, the CPU may then provide that frame to an initialized object detection TPU 1204 to begin performing object detection inference on frame i.

Soon thereafter (e.g., while the object detection TPU 1204 is still performing object detection), the camera 1202 may begin capturing the next frame i+1, and begin reading the next corresponding altitude and acceleration values from the altimeter 1208 and the accelerometer 1210, respectively. Once the object detection TPU 1204 has completed performing object detection on frame i and has returned the detections, the CPU may then provide frame i and the detections to an object tracking module, which leverages a feature extraction TPU 1206 initialized to extract feature descriptors of each ROI associated with each detection.

In parallel with the feature extraction for frame i by the feature extraction TPU 1206, the camera 1202 may begin capturing the next frame i+2, and begin reading the next corresponding altitude and acceleration values from the altimeter 1208 and the accelerometer 1210, respectively. In addition, the CPU may provide frame i+1 (which has now returned and is stored in memory) to the object detection TPU 1204 to perform object detection on frame i+1. In other words, before the feature extraction for frame i has completed, the second effective iteration of the event loop is already well under way, and the third effective iteration of the event loop has already been initiated.

After the feature extraction TPU 1206 has completed performing feature extraction on the detections for frame i (and object trackers have been updated), the first iteration of the “pipelined” event loop is deemed to be complete at time 1220. Soon after time 1220, the feature extraction TPU 1206 is ready to receive frame i+1 and its associated detections determined by the object detection TPU 1204 while the feature extraction TPU 1206 was performing feature extraction on frame i. Once the feature extraction TPU 1206 has completed performing feature extraction on the detections for frame i+1 (and object trackers have been updated), the second iteration of the “pipelined” event loop is deemed to be complete at time 1222. Likewise, once the feature extraction TPU 1206 has completed performing feature extraction on the detections for frame i+2 (and object trackers have been updated), the third iteration of the “pipelined” event loop is deemed to be complete at time 1224.

In this manner, although the first iteration of the pipeline might not be significantly faster than a typical sequentially-executed event loop, the duration of time between the completion of subsequent event loops is significantly decreased. In effect, pipelining the execution of the event loop in this manner may enable the event loop to execute in approximately the amount of time it takes to complete the slowest operation in the pipeline (e.g., object detection or object tracking, depending on how many trackers are being updated). In practice, this enables a pipeline which previously took 40-80 milliseconds to be completed in 20-30 milliseconds on average—leading to a substantial improvement in object tracking performance, as the time step in between frames is significantly lower, and therefore the distance an object travels in between consecutive frames is significantly smaller.

In various implementations, it may be desirable to limit elevator occupancy during certain periods of the day to just one or two passengers at a time. For example, a building may house persons that are vulnerable to certain infectious diseases, such as elderly persons and/or immunocompromised persons. As a result, it may be desirable to limit elevator occupancy to a lower threshold during certain times of day, to allow those vulnerable persons to travel through the elevator system more safely. Accordingly, the thresholds (such as the occupancy limit threshold) of a sensor module according to the present application may be configurable and change based on the time of day, a predetermined schedule, or manually by a user or administrator.

In various implementations, it may be desirable to detect objects other than persons, such as mobility aids, stretchers, and/or hospital equipment. A known issue with hospital elevator efficiency is caused by a mixture of “vehicle” traffic (e.g., hospital equipment) and people traffic (e.g., patients, nurses, doctors, etc.). Sometimes, an elevator may be loaded with medical equipment that is particularly voluminous, thereby taking up a substantial portion of the available space in the elevator. If such a fully-loaded elevator with few occupants but lots of medical equipment is permitted to operate normally, that elevator may make one or more unnecessary stops on its journey, responding to hall calls even though little to no room is available on the elevator for those waiting passengers. To allay this issue, sensor modules according to the present disclosure may detect objects such as medical equipment and determine the extent to which the elevator is “full,” at least in the sense of how much area or volume is available for additional passengers. Based on the number of medical devices detected, and/or based on the available volume in the cab for additional occupants, sensor modules of the present disclosure may activate a bypass feature of the elevator to prevent the above-described unnecessary stops.

Similar to the above-described example, it may be desirable to detect objects such as boxes, dollies, and other moving equipment. A common practice in residential buildings with elevators involves dedicating an elevator to serve one tenant that is either moving in or moving out of the building. While this practice is often seen as necessary to reduce the amount of time the move requires, it can be detrimental to the elevator service of the other tenants in the building, as there are fewer elevators to serve substantially the same building population during the move. To address this issue, sensor modules of the present disclosure may detect objects such as boxes, dollies, and/or other moving equipment and, if they are detected, activate a bypass feature of the elevator so that the moving individuals experience an express ride without intermediate stops to their destination. This may be accomplished by merely detecting one or more “trigger” objects, counting the number of moving-related objects in the scene and comparing that number to a threshold, and/or estimating the available volume in the elevator and comparing that available volume to a threshold. In doing so, the movers may have substantially the same experience as having a dedicated elevator, while minimally disrupting the elevator service of other occupants in the building when the movers are not using the elevator.

In some cases, it may be desirable to classify attributes of a person, such as their gender, gender identity, sex, age, ethnicity, or other characteristic. The present application contemplates implementations in which the model used to detect persons may be also used to perform feature extraction to classify one or more characteristics of a person. For example, a model may identify whether the person is a man or a woman, or estimate the age of the person. Based on these extracted characteristics of the occupant or occupants in an elevator, the sensor module may transmit the extracted occupancy demographic information to other subsystems, such as advertising displays in the elevator cab. In this manner, ads likely to be relevant to the current passengers in the cab may be produced in real time.

In various implementations, it may be desirable to activate a bypass feature of the elevator when departing from one or more floors. For example, a high-paying tenant may wish to have express rides from their floor (at all times, or during certain windows of time) so that, for instance, their employees can more quickly travel through the building (e.g., traders needing to have minimal travel times to avoid missing time-sensitive deals). In these examples, sensor modules of the present application may be configurable to activate a bypass feature of the elevator when departing from a particular floor or floors.

In various implementations, it may be desirable to activate a bypass feature of the elevator in response to detecting a particular passenger, detecting a visual barcode, detecting a wireless signature (e.g., BLE signature), and/or upon detecting a particular pose or human behavior. In each of these examples, certain persons may be given express rides, either through automatic detection, by performing a gesture, or by holding up a scannable barcode to the sensor module's camera.

In various implementations, BLE beacons may be used to calibrate the relative of position of the sensor module during operation. For example, a BLE beacon may be affixed near the ground floor landing in the hoistway of an elevator. The sensor module may be configured to detect the BLE beacon's emitted message and estimate the distance between the BLE beacon and the sensor module based on the BLE beacon's known broadcast power and distance formulas known to persons of ordinary skill in the art. Upon determining that the sensor module is within a threshold distance of the BLE beacon, the sensor module may record the most recent altitude measurement (and/or the Kalman-filtered altitude measurement), which may serve as a reference altitude associated with that particular floor. Due to natural changes in barometric pressure, it may be desirable to update the absolute altitude associated with a particular floor relatively frequently (e.g., once an hour) such relative altitude calculations based on this reference altitude can be relied upon to estimate, for example, the floor nearest to the sensor module.

In various implementations, it may be desirable to display on the display module of the sensor module the floor that the elevator is on, which may be inferred from the detected or tracked altitude of the sensor module and known floor heights of the building. The sensor module may be customized so that a company's logo appear upon arrival at a particular floor.

In various embodiments, it may be desirable to analyze the collected data to determine when the peak elevator traffic periods occur throughout the day. Elevator utilization may be generally defined based on the number of passengers per trip and the duration the elevator spends picking up and dropping off passengers relative to the duration the elevator is idle over a given period of time. Analyzing elevator utilization over the course of a day, week, or some other period of time, the peak traffic periods of the day may be

In some embodiments, the sensor module may adaptively modify one or more thresholds (e.g., the occupancy limit threshold) based at least in part on the current demand of an elevator or elevator system. For example, the elevators in a bank may be equipped with sensor modules that typically limit elevator occupancy to two passengers at a time. However, if the elevator utilization across the bank exceeds some threshold level of utilization (e.g., 70%, among other utilization thresholds) then the sensor modules may responsively modify the occupancy limit threshold to three or four passengers at a time. In this manner, the elevator system may avoid overloading the elevator system by strictly enforcing an occupancy limit, irrespective of the current passenger demand. This “adaptive occupancy limit” feature may be configured to suit the needs of a particular building, with different occupancy limits than those described in the example above.

In some embodiments, the sensor module of the present application and/or an associated backend server or cloud application may be adapted to communicate with one or more of a building automation system, a work order system, or the like. As a specific example, it may be desirable to clean or sanitize a particular elevator after a threshold number of persons have travelled through that elevator (rather than simply cleaning the elevators on a regular schedule, irrespective of actual foot traffic). For instance, a building manager may wish to clean an elevator after 50 or more passengers have used it. The sensor module, backend server, and/or a cloud application may determine the number of persons that have travelled through the elevator system since it was last cleaned. If the number of persons exceeds a threshold, the sensor module, backend server, and/or a cloud application may transmit a request to the building automation system, work order system, or the like to create a cleaning ticket or order to clean or sanitize the elevator. In this manner, the management of elevator sanitation may be automated with little to no human intervention.

In various implementations, it may be desirable to detect things other than persons, such as cats, dogs, or other pets. A building with multiple elevators may designate one or more of those elevators for pets, with pets being prohibited in the remaining elevators. To monitor the compliance of these rules, the sensor module may employ an object detection model that is trained to detect persons and pets. In an example implementation, the sensor module may determine whether one or more pets are present within the FOV of the camera module. If the sensor module detects the presence of one or more pets in violation of a building rule, the sensor module may notify building staff, generate an auditory or visual alert, and/or log the event for later inspection by a building manager. In some cases, a compliance “score” may be calculated that reflects how often the pet-designation elevator rules are adhered to.

In some implementations, the camera module may be positioned at an elevated position (such as along the ceiling or drop ceiling of an elevator) such that the adverse effects of occlusion can be minimized. In situations where an elevator is densely loaded (e.g., 8 or more passengers), the likelihood that one person partially or wholly occludes another person from the perspective of a corner-mount camera is high. If occlusion continues for a sufficiently long duration, the occluded person may fail to be detected, and the corresponding tracker of the person may be forgotten—leading to an inaccurate person count and a “forgotten” tracker. It may be desirable to have trackers be maintained continuously from when a person enters an elevator and until that person exits the elevator, such that metadata associated with that tracker may be used to record information about that particular passenger's elevator journey (e.g., start time, end time, start floor, end floor, etc.). Accordingly, various camera angles are contemplated herein which may reduce the likelihood of occlusion and, in turn, enable the people counting and tracking applications disclosed herein to operate at sufficiently high accuracy levels, even in crowded elevators.

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents.

We claim:

1. A sensor module comprising:
a camera module comprising an image processor and a lens that collectively capture image data representative of a field of view (FOV) a scene;
a machine learning (ML) inference application-specific integrated circuit (ASIC) programmable to implement a deep neural network (DNN), and configured to generate inference outputs based on input data;
a general purpose input output (GPIO) selectively controllable to output at least one of a low voltage state and a high voltage state;
at least one processor; and
a non-transitory storage medium storing instructions thereon that, upon execution by the at least one processor, performs operations comprising:
capturing, by the camera module, image data of the FOV of the camera module;
detecting, based on the captured image data, the presence of one or more persons within the FOV of the camera using the ML ASIC;
counting, by the at least one processor, a number of persons detected within the FOV of the camera; and
based on the counted number of persons exceeding a threshold, driving the GPIO from the low voltage state to the high voltage state.

2. The sensor module of claim 1, further comprising:
a relay operably coupled to the GPIO, wherein the relay operates in a first state when the GPIO is in the low volage stage and a second state when the GPIO is in the high voltage state.

3. The sensor module of claim 1, wherein the non-transitory storage medium stores further instructions thereon that, upon execution by the at least one processor, performs additional operations comprising:
determining, based on the detected presence of the one or more persons, one or more trackers,
wherein counting the number of persons detected within the FOV of the camera comprises counting the one or more trackers.

4. The sensor module of claim 3, wherein the ML ASIC is a first ML ASIC, wherein the DNN is a first DNN, and wherein the sensor module further comprises:
a second ML ASIC programmable to implement a second DNN, and configured to generate a feature vector based on an input image segment,
wherein determining the one or more trackers further comprises:
determining, based on the captured image data and the detected presence of one or more persons within the FOV of the camera, one or more respective feature vectors corresponding to the one or more detected persons; and
determining the one or more persons based on the detected presence of the one or more persons and the respective one or more feature vectors.

5. The sensor module of claim 4, further comprising:
an accelerometer configured to measure acceleration,
wherein the non-transitory storage medium stores further instructions thereon that, upon execution by the at least one processor, performs additional operations comprising:
determining, by the accelerometer, an acceleration of the system,
wherein driving the GPIO from the low voltage state to the high voltage state is further based on the determined acceleration.

6. The sensor module of claim 1, further comprising:
an altimeter configured to measure barometric pressure, wherein the non-transitory storage medium stores further instructions thereon that, upon execution by the at least one processor, performs additional operations comprising:
determining, by the altimeter, a barometric pressure around the system; and
determining an altitude of the system based on the determined barometric pressure,
wherein driving the GPIO from the low voltage state to the high voltage state is further based on the determined acceleration.

7. The sensor module of claim 1, further comprising:
a wireless transceiver configured to transmit information between the sensor module and a computing device,
wherein the non-transitory storage medium stores further instructions thereon that, upon execution by the at least one processor, performs additional operations comprising:
receiving, via the wireless transceiver, a message indicative of a configuration of the sensor module,
wherein driving the GPIO from the low voltage state to the high voltage state is further based on the received configuration of the sensor module.

8. The sensor module of claim 1, wherein the DNN is a convolutional neural network that performs object detection.

9. The sensor module of claim 1, wherein the DNN is a convolutional neural network that performs image segmentation.

10. The sensor module of claim 1, wherein the DNN is a convolutional neural network that performs human pose estimation.

11. A computer-implemented method comprising:
capturing, by a camera, a first frame of a scene within the field of view (FOV) of the camera;
determining, based on the first frame, one or more detections indicative of the presence of one or more persons within the FOV of the camera using a deep neural network (DNN);
while determining the one or more detections for the first frame, capturing, by the camera, a second frame of the scene within the FOV of the camera;
after determining the one or more detections based on the first frame, determining based on the first frame and the one or more detections, one or more trackers representative of the one or more persons within the FOV of the camera
while determining the one or more trackers for the first frame, determining one or more detections for the second frame;
while determining the one or more detections for the second frame, capturing, by the camera a third frame of the scene; and
after determining the one or more trackers for the first frame, and while determining the one or more detections for the second frame, transmitting information representative of the one or more trackers to a computing device.

12. A system comprising:
a camera module comprising an image processor and a lens that collectively capture image data representative of a field of view (FOV) a scene;
a wireless transceiver configured to transmit information to a computing device;
an accelerometer configured to measure acceleration;
an altimeter configured to measure barometric pressure;
at least one processor; and
a non-transitory storage medium storing instructions thereon that, upon execution by the at least one processor, performs operations comprising:
determining, by the accelerometer, an acceleration of the system;
determining, by the altimeter, an altitude of the system;
capturing, by the camera module, image data of the FOV of the camera module;
detecting, based on the captured image data, the presence of one or more persons within the FOV of the camera using a deep neural network;
counting, by the at least one processor, a number of persons detected within the FOV of the camera; and
transmitting, by the wireless transceiver, a data payload that includes at least (i) a representation of the determined acceleration, (ii) a representation of the determined altitude, and (iii) the detected number of persons.

13. The system of claim 12, further comprising:
a machine learning (ML) inference application-specific integrated circuit (ASIC) programmable to implement a deep neural network (DNN), and configured to generate inference outputs based on input data,
wherein detecting the presence of the one or more persons comprises transmitting the image data to the ML ASIC and receiving one or more detections representative of the detected presence of the one or more persons.

14. The system of claim 12, wherein the non-transitory storage medium stores further instructions thereon that, upon execution by the at least one processor, performs additional operations comprising:
determining a kinematic state of the system based on the determined acceleration and the determined altitude.

15. The system of claim 14, wherein the data payload further includes at least (iv) a representation of the determined kinematic state of the system.

16. The system of claim 12, wherein the non-transitory storage medium stores further instructions thereon that, upon execution by the at least one processor, performs additional operations comprising:
determining, using a Kalman filter, an estimated acceleration of the system based on the determined acceleration and the determined altitude;
determining, using the Kalman filter, an estimated altitude of the system based on the determined acceleration and the determined altitude; and
determining a kinematic state of the system based on the estimated acceleration and the estimated altitude.
